(19) United States
(12) Patent Application Publication
(10) Pub. No.: US 2018/0320751 A1
(43) Pub. Date: Nov. 8, 2018

(54) CYLINDER DEVICE

(71) Applicant: HITACHI AUTOMOTIVE SYSTEMS, LTD., Ibaraki (JP)

(72) Inventors: Kosuke KADOKURA, Atsughi-shi, Kanagawa (JP); Yasuhiro AOKI, Yokohama-shi, Kanagawa (JP); Yusei KIMURA, Kawasaki-shi, Kanagawa (JP)

(21) Appl. No.: 15/740,651

(22) PCT Filed: Aug. 18, 2016
(86) PCT No.: PCT/JP2016/074068

§ 371 Date: Dec. 28, 2017

(30) Foreign Application Priority Data
Jun. 30, 2015 (JP) 2015-131318
Feb. 25, 2016 (JP) 2016-034290

(51) Int. Cl. F16F 9/32; F16F 9/52; F16F 9/53; F16F 9/04

(52) U.S. Cl. CPC F16F 9/325; F16F 9/523; F16F 13/30; F16F 9/0472; F16F 9/532

(57) ABSTRACT

Electro-rheological fluid serving as working fluid (2) is filled in a shock absorber (1). The shock absorber (1) is configured to control a generated damping force by generating an electric potential difference in an electrode passage (19) and controlling viscosity of the electro-rheological fluid which passes through the electrode passage (19). An adjusting valve (21) configured to generate a damping force is provided on a downstream side of the electrode passage (19). An orifice area, a spring stiffness, a port area, and the like of the adjusting valve (21) can be adjusted (changed) in accordance with a type, specifications, and the like of a vehicle in which the shock absorber (1) is installed. As a result, the damping force characteristic can be tuned as desired by a method other than adjustment of the damping force through voltage adjustment when the working fluid (2) passes through the electrode passage (19).

### TECHNICAL FIELD

The present invention relates to a cylinder device which is suitably used for absorbing vibration of a vehicle such as an automobile or a railway vehicle.

### BACKGROUND ART

In general, a vehicle such as an automobile includes a cylinder device as typified by a hydraulic shock absorber, which is provided between a vehicle body (sprung) side and each wheel (unsprung) side, in Patent Literature 1, there is disclosed a configuration of a damper (shock absorber) employing electro-rheological fluid. According to the disclosed configuration, fluid which has passed between an inner tube and an electrode tube (intermediate tube) is caused to directly flow to a reservoir chamber. Referring to FIG. 1 of Patent Literature 1, a check valve (14) is provided to a top cylinder cover (27). The check valve (14) is configured to prevent a counter flow of gas in a as pressure chamber (9) in an outer annular space (19), which is the reservoir chamber. In other words, the check valve (14) is not a valve configured to generate a damping force.

A hydraulic damper disclosed in Patent Literature 2 is configured to change a flow passage area of a damping passage (annular oil passage) in a piston in accordance with the temperature of working fluid in order to suppress a characteristic change (change in damping force) caused by a change in viscosity (flow resistance) of the working fluid along with the temperature change.

### CITATION LIST

### Patent Literature

PTL 1: WO 2014/135183 A1

PTL 2: JP 2008-101638 A (JP 4754456 B2)

### SUMMARY OF INVENTION

### Technical Problem

For example, in a damper employing electro-rheological fluid, it is desired that a damping force characteristic can be tuned (adjusted) in the damper by a method other than voltage adjustment.

An object of the present invention to provide a cylinder device capable of tuning the damping force characteristic as desired.

### Solution To Problem

According to one embodiment of the present invention, there is provided a cylinder device, including: an inner tube in which functional fluid having a characteristic that is changed by electric field or magnetic field is sealed; a piston, which is provided in the inner tube so as to be slidable, and defines a first chamber on a rod side and a second chamber on a bottom side in the inner tube; a piston rod, which has one end coupled to the piston, and another end extending to an outside of the inner tube via the first chamber; an intermediate tube, which is provided on an outer side of the inner tube, and forms, together with the inner tube, an intermediate passage serving as an electrode passage or a magnetic pole passage communicating with the first chamber; an outer tube, which is provided around an outer periphery of the intermediate tube, and forms, together with the intermediate tube, a reservoir communicating with the intermediate passage; a body valve, which is provided on one end side of the inner tube, and is configured to allow and block communication between the second chamber and the reservoir; and an adjusting valve, which is configured to generate a damping force, and is provided in a first passage configured to allow the first chamber and the reservoir to communicate with each other via the intermediate passage.

The cylinder device according to one embodiment of the present invention is capable of tuning the damping force characteristic as desired. In other words, the damping force characteristic of the cylinder device can be tuned as desired based on the setting of the adjusting valve provided in the first passage in addition to the adjustment of the damping force which is generated when the functional fluid passes through the intermediate passage (electrode passage or magnetic pole passage).

### BRIEF DESCRIPTION OF DRAWINGS

FIG. 1 is a longitudinal sectional view for illustrating a shock absorber as a cylinder device according to a first embodiment.

FIG. 2 is an enlarged sectional view of a portion (II) of FIG. 1 for illustrating an electrode passage, a first passage, an adjusting valve, and the like.

FIG. 3 is a characteristic line graph for showing an example of a relationship between a piston speed and a damping force.

FIG. 4 is a longitudinal sectional view for illustrating a shock absorber as a cylinder device according to a second embodiment.

FIG. 5 is an enlarged sectional view of a portion (V) of FIG. 4 for illustrating an electrode passage, a first passage, an adjusting valve, and the like.

FIG. 6 is a longitudinal sectional view for illustrating a shock absorber as a cylinder device according to a third embodiment.

FIG. 7 is an enlarged sectional view of a portion (VII) of FIG. 6 for illustrating an electrode passage, a first passage, an adjusting valve, and the like.

FIG. 8 is a longitudinal sectional view for illustrating a shock absorber as a cylinder device according to a fourth embodiment.

FIG. 9 is an enlarged sectional view for illustrating a portion (IX) of FIG. 8.

FIG. 10 is an enlarged sectional view for illustrating a portion (X) of FIG. 9.

FIG. 11 is a perspective view for illustrating a damping force adjusting valve.

FIG. 12 is a characteristic line graph for showing another example of the relationship between the piston speed and the damping force.

Now, description is made of a cylinder device according to embodiments with reference to accompanying drawings while exemplifying a case where the cylinder device is applied to a shock absorber provided to a vehicle such as a four-wheel automobile.

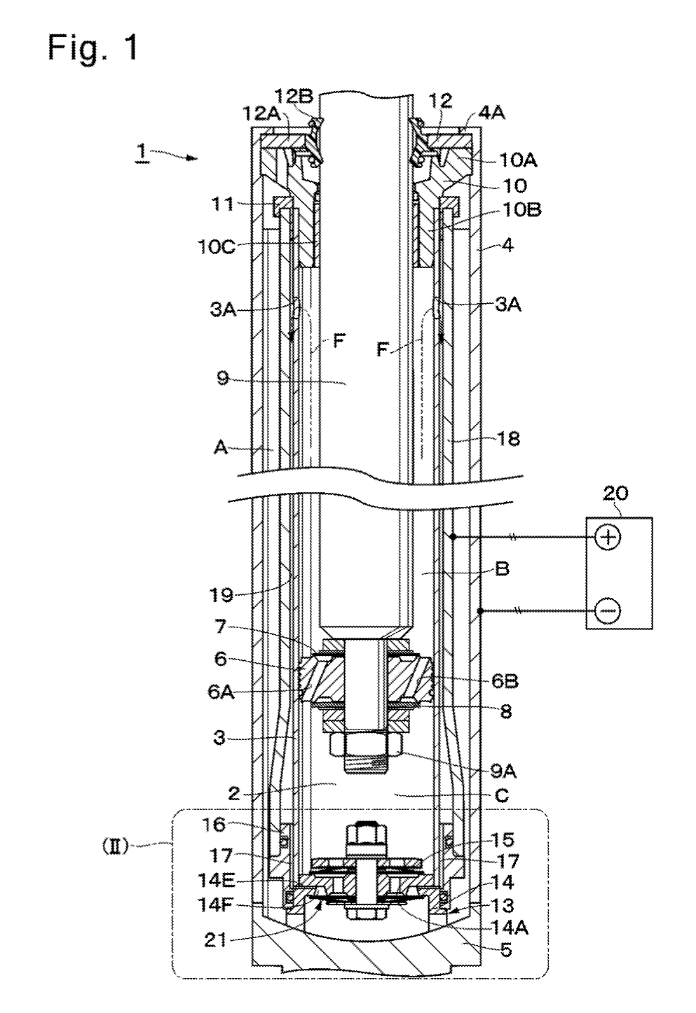

FIG. 1 to FIG. 3 are illustrations of a first embodiment. In FIG. 1, a shock absorber 1 as a cylinder device is constructed as a hydraulic shock absorber (semi-active damper) of an adjustable damping three type employing functional fluid (that is, electro-rheological fluid) as working fluid 2 such as working oil sealed in the shock absorber. The shock absorber 1 constructs a suspension device for a vehicle together with, for example, a suspension spring (not shown) formed of a coil spring. Hereinafter, one end side in an axial direction of the shock absorber 1 is referred to as “bottom end” side, and another end side in the axial direction is referred to as “top end” side. However, the one end side in the axial direction of the shock absorber 1 may be the “top end” side, and the another end side in the axial direction may be the “bottom end” side.

The shock absorber 1 includes an inner tube 3, an outer tube 4, a piston 6, a piston rod 9, a bottom valve 13, and an electrode tube 18. The inner tube 3 is formed as a tubular body having a cylindrical shape and extending in the axial direction, and the working fluid 2, which is the functional fluid, is sealed in the inner tube 3. Further, the piston rod 9 described later is inserted inside the inner tube 3, and the outer tube 4 and the electrode tube 18 described later are coaxially provided on an outer side of the inner tube 3.

A bottom end side of the inner tube 3 is mounted through fitting to a valve body 14 of the bottom valve 13 described later, and a top end side of the inner tube 3 is mounted through fitting to a rod guide 10 described later. A plurality of (for example, four) oil holes 3A always communicating with an electrode passage 19 described later are formed in the inner tube 3 as horizontal holes in a radial direction so as to be separated from one another in a circumferential direction. In other words, a rod-side oil chamber B inside the inner tube 3 communicates with the electrode passage 19 through the oil holes 3A.

The outer tube 4 forms an outer shell of the shock absorber 1, and is thrilled as a cylindrical body. The outer tube 4 is provided around an outer periphery of the electrode tube 18, and forms a reservoir chamber A communicating with the electrode passage 19 between the outer tube 4 and the electrode tube 18. In this case, a bottom end side of the outer tube 4 is a closed end which is closed by a bottom cap 5 through welding means or the like. The bottom cap 5 constructs a base member together with the valve body 14 of the bottom valve 13.

A top end side of the outer tube 4 is an open end. For example, a crimped part 4A is formed on the open end side of the outer tube 4 by bending the top end side of the outer tube 4 radially inward. The crimped part 4A is configured to hold an outer peripheral side of an annular plate body 12A of a seal member 12 described later in a state of preventing detachment.

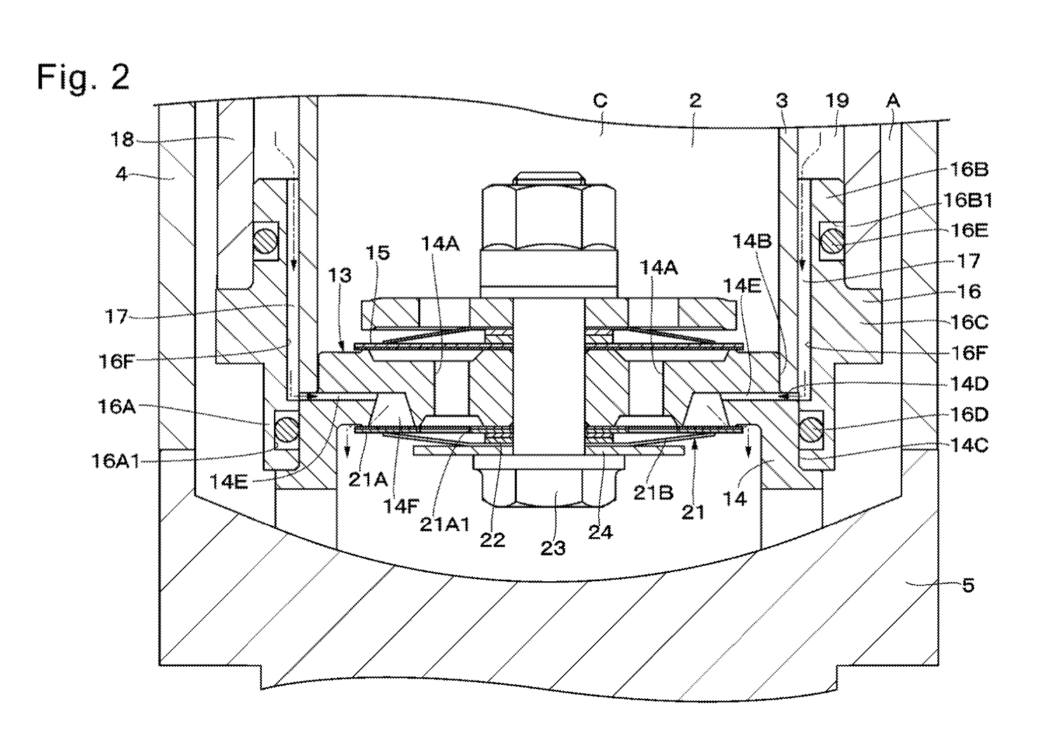

The inner tube 3 and the outer tube 4 construct a cylinder, and the working fluid 2 is sealed in the cylinder. In the embodiment, as the fluid tilled (sealed) in the cylinder, that is, as the working fluid 2 serving as the working oil, electro-rheological fluid (ERF), which is a type of functional fluid, is employed. In FIG. 1 and FIG. 2, the sealed working fluid 2 is illustrated as being colorless and transparent.

The electro-rheological fluid is fluid having a characteristic that is changed by electric field (voltage). In other words, a flow resistance (damping three) of the electro-rheological fluid is changed in accordance with the applied voltage. The electro-rheological fluid is formed of, for example, base oil, which is formed of silicon oil or the like, and particles (particulates), which are mixed with (dispersed in) the base oil and cause the viscosity to be variable in accordance with a change in the electric field.

As described later, the shock absorber 1 is configured to generate an electric potential difference in the electrode passage 19 between the inner tube 3 and the electrode tube 18 to control the viscosity of the electro-rheological fluid passing through the electrode passage 19, thereby controlling (adjusting) the generated clamping three. In the embodiment, description is made of the electro-rheological fluid (ER fluid) as the functional fluid. However, for example, magneto-rheological fluid (MR fluid) having a characteristic that is changed by magnetic field may be used as the functional fluid.

The reservoir chamber A having an annular shape and serving as a reservoir is formed between the inner tube 3 and the outer tube 4, more specifically, between the electrode tube 18 and the outer tube 4. In the reservoir chamber A, gas serving as working gas is sealed together with the working fluid 2. Examples of the gas may include air at atmospheric pressure and gas such as a compressed nitrogen gas. The gas in the reservoir chamber A is compressed to compensate a volume corresponding to an amount of entry of the piston rod 9 at the time of retraction (retraction stroke) of the piston rod 9.

The piston 6 is provided in the inner tube 3 so as to be slidable. The piston 6 defines the rod-side oil chamber B serving as a first chamber and a bottom-side oil chamber. C serving as a second chamber in the inner tube 3. A plurality of oil passages 6A and a plurality of oil passages 6B configured to allow communication between the rod-side oil chamber B and the bottom-side oil chamber C are formed in the piston 6 so as to be separated from one another in the circumferential direction.

The shock absorber 1 according to the embodiment has a uni-flow structure. Therefore, the working fluid 2 in the inner tube 3 always flows in one direction (that is, in a direction of arrows F indicated by two-dot chain lines of FIG. 1) from the rod-side oil chamber B (that is, the oil holes 3A in the inner tube 3) toward the electrode passage 19 both in a retraction stroke and an extension stroke of the piston rod 9.

In order to achieve such uni-flow structure, for example, a retraction-side check valve 7 as a first check valve is provided on a top end surface of the piston 6. The retraction-side check valve 7 is opened when the piston 6 is slid and displaced downward in the inner tube 3 in the retraction stroke of the piston rod 9, and is closed otherwise. The retraction-side check valve 7 is configured to allow the oil liquid (working fluid 2) in the bottom-side oil chamber C to flow through each of the oil passages 6A toward the rod-side oil chamber B, and block a flow of the oil liquid in an opposite direction. In other words, the retraction-side cheek valve 7 is configured to permit only the flow of the working fluid 2 from the bottom-side oil chamber C to the rod-side oil chamber B.

For example, an extension-side disc valve 8 is provided on a bottom end surface of the piston 6. When the piston 6 is slid and displaced upward in the inner tube 3 in the extension stroke of the piston rod 9, and a pressure in the rod-side oil chamber B exceeds a relief set pressure, the extension-side disc valve 8 is opened, and relieves the pressure on this occasion to the bottom-side oil chamber C side via the respective oil passages 6B.

The piston rod 9 extends in an axial direction in the inner tube 3 (the same direction as a center axis of the inner tube 3 and the outer tube 4, consequently a center axis of the shock absorber 1, and a vertical direction of FIG. 1 and FIG. 2). In other words, a bottom end of the piston rod 9 is coupled (fixed) to the piston 6 in the inner tube 3, and a top end of the piston rod 9 extends to the outside of the inner tube 3 and the outer tube 4 via the rod-side oil chamber B. In this case, the piston 6 is fixed (fastened) to the bottom end side of the piston rod 9 through use of a nut 9A or the like. Meanwhile, a top end side of the piston rod 9 protrudes to the outside via the rod guide 10. The bottom end of the piston rod 9 may be further extended, and may be protruded outward from a bottom part (for example, the bottom cap 5) side. Thus, a so-called double-rod cylinder may be formed.

The rod guide 10 having a stepped cylindrical shape is provided through fitting on top end sides of the inner tube 3 and the outer tube 4 so as to close the top end sides of the inner tube 3 and the outer tube 4. The rod guide 10 is configured to support the piston rod 9, and is formed as a tubular body having a predetermined shape, for example, by performing molding, cutting, and the like on a metal material, a hard resin material, or the like. The rod guide 10 is configured to position a top-side portion of the inner tube 3 and, a top-side portion of the electrode tube 18 described later at a center of the outer tube 4. In addition, the rod guide 10 is configured to guide the piston rod 9 so as to allow the piston rod 9 to slide in the axial direction on an inner peripheral side of the rod guide 10.

The rod guide 10 is formed into the stepped cylindrical shape including an annular large diameter part 10A and a short and tubular small diameter part 10B. The large diameter part 10A is positioned on a top side of the rod guide 10, and is inserted into and fitted to an inner peripheral side of the outer tube 4. The small diameter part 10B positioned on a bottom end side of the large diameter part 10A, and is inserted into and fitted to an inner peripheral side of the inner tube 3. A guide part 10C configured to guide the piston rod 9 so as to allow the piston rod 9 to slide in the axial direction is provided on an inner peripheral side of the small diameter part 10B of the rod guide 10. The guide part 10C is formed, for example, by applying tetrafluoroethylene coating to an inner peripheral surface of a metal tube.

Meanwhile, an annular holding member 11 is mounted through fitting on an outer peripheral side of the rod guide 10 between the large diameter part 10A and the small diameter part 10B. The holding member 11 holds a top end side of the electrode tube 18, which is described later, while positioning the top end side of the electrode tube 18 in the axial direction. The holding member 11 is made of, for example, an electrically insulating material (isolator), and is configured to maintain an electrically insulated state between the inner tube 3 and the electrode tube 18 and between the rod guide 10 and the electrode tube 18.

An annular seal member 12 is provided between the large diameter part 10A of the rod guide 10 and the crimped part 4A of the outer tube 4. The seal member 12 includes an annular plate body 12A and an elastic body 12B. The annular plate body 12A is made of metal, and has a hole formed at a center to allow the piston rod 9 to be inserted therethrough. The elastic body 12B is made of an elastic material such as rubber, and is fixed to the annular plate body 12A through vulcanization bonding or the like. An inner periphery of the elastic body 12B of the seal member 12 is held in slide-contact with an outer peripheral side of the piston rod 9, thereby sealing a gap between the piston rod 9 and the seal member 12 in a liquid-tight and air-tight manner.

The bottom valve 13 is provided on a bottom end side of the inner tube 3 at a position between the inner tube 3 and the bottom cap 5. The bottom valve 13 serving as a body valve is configured to allow and block communication between the bottom-side oil chamber C and the reservoir chamber A. Therefore, the bottom valve 13 includes the valve body 14 and an extension-side check valve 15 serving as a second check valve. The valve body 14 defines the reservoir chamber A and the bottom-side oil chamber C between the bottom cap 5 and the inner tube 3.

Oil passages 14A configured to allow the communication between the reservoir chamber A and the bottom-side oil chamber C are formed at intervals in the circumferential direction in the valve body 14. A small diameter part 14B positioned on a top side, and a large diameter part 14C positioned on a bottom end side of the small diameter part 14B are formed on an outer peripheral side of the valve body 14. An inner peripheral side of a bottom end of the inner tube 3 is fixed through fitting to the small diameter part 14B. An inner peripheral side of a bottom end of the holding member 16 described later is fixed through fitting to the large diameter part 14C. A step part 14D against which the bottom end of the inner tube 3 is held in abutment is formed between the small diameter part 14B and the large diameter part 14C. A bottom end edge of the inner tube 3 is held in abutment against the step part 14D.

A plurality of radial passages 14E extending in the radial direction are formed at intervals in the circumferential direction in the valve body 14. In this case, each of the radial passages 14E includes a recessed groove and an oil hole. The recessed groove is formed in the step part 14D and extends in the radial direction. The oil hole extends toward a center axis side of the valve body 14 so as to be continuous with the recessed groove. Each of the radial passages 14E is connected to an annular passage 14F formed on a bottom surface side of the valve body 14 so as to surround the oil passages 14A. The annular passage 14F has an annular recessed groove opening on the bottom surface side of the valve body 14. The radial passages 14E and the annular passage 14F form, together with holding-member-side passages 17 described later, a first passage through which the working fluid 2 flows. Further, an adjusting valve 21 described later is provided in the annular passage 14F so as to cover the annular passage 14F.

The extension-side check valve 15 is provided, for example, on a top surface side of the valve body 14. The extension-side check valve 15 is opened when the piston 6 is slid and displaced upward in the extension stroke of the piston rod 9, and is closed otherwise. The extension-side check valve 15 is configured to allow the oil liquid (working fluid) in the reservoir chamber A to flow through each of the oil passages 14A toward the bottom-side oil chamber C, and block a flow of the oil liquid in an opposite direction. In other words, the extension-side cheek valve 15 is configured to permit only the flow of the working fluid 2 from the reservoir chamber A side to the bottom-side oil chamber C side.

The holding member 16 is mounted through fitting to an outer peripheral side of bottom ends of the large diameter part 14C of the valve body 14 and the inner tube 3. The holding member 16 holds a bottom end side of the electrode tube 18 while positioning the bottom end side of the electrode tube 18 in the axial direction. The holding member 16 is made of, for example, an electrically insulating material (isolator), and is configured to maintain an electrically insulated state between the inner tube 3 and the electrode tube 18 and between the valve body 14 and the electrode tube 18.

The holding member 16 includes a bottom-side tube part 16A serving as a first tube part, a top-side tube part 16B serving as a second tube part, and an annular flange part 16C. The bottom-side tube part 6A is fitted to the large diameter part 14C of the valve body 14. A seal groove 16A1 serving as a circumferential groove is formed over an entire periphery in an inner peripheral surface of the bottom-side tube part 16A. A seal member 16D configured to seal, in a liquid-tight manner, a gap between the holding member 16 and the valve body 14 is provided in the seal groove 16A1.

Meanwhile, the top-side tube part 16B is fitted to the inner tube 3. Further, an inner peripheral side of the bottom end of the electrode tube 18 is fitted to an outer peripheral side of the top-side tube part 16B. A seal groove 16B1 serving as a circumferential groove is formed over an entire periphery in a portion of an outer peripheral surface of the top-side tube part 16B corresponding to the electrode tube 18. A seal member 16E configured to seal, in a liquid-tight manner, a gap between the holding member 16 and the electrode tube 18 is provided in the seal groove 16B1. The annular flange part 16C is provided on an outer peripheral side of the top-side tube part 16B. The bottom end of the electrode tube 18 is held in abutment against the annular flange part 16C. As a result, the annular flange part 16C positions the electrode tube 18 in the axial direction.

A plurality of recessed grooves 16F extending in the axial direction are formed in an inner peripheral surface of the holding member 16 at portions opposed to an outer peripheral surface of the inner tube 3 in the radial direction and portions opposed to the radial passages 14E of the large diameter part 14C of the valve body 14. Each of the recessed grooves 16F is connected to each of the radial passages 14E. The recessed grooves 16F form the plurality of holding-member-side passages 17 extending in the axial direction between an inner diameter side of the holding member 16 and the outer peripheral surface of the inner tube 3.

The holding-member-side passages 17 are connected to the radial passages 14E and the annular passage 14F of the valve body 14. As a result, the holding-member-side passages 17, the radial passages 14E, and the annular passage 14F construct the first passage configured to allow the rod-side oil chamber B and the reservoir chamber A to communicate with each other via the electrode passage 19. In other words, the electrode passage 19 and the reservoir chamber A communicate with each other via the holding-member-side passages 17, the radial passages 14E, and the annular passage 14E.

The electrode tube 18 formed of a pressure tube extending in the axial direction is provided on an outer side of the inner tube 3, that is, between the inner tube 3 and the outer tube 4. The electrode tube 18 serves as an intermediate tube between the inner tube 3 and the outer tube 4. The electrode tube 18 is made of a conductive material, and forms a tubular electrode. The electrode tube 18 firms the electrode passage 19 communicating with the rod-side oil chamber B in a gap between the inner tube 3 and the electrode tube 18.

In other words, the electrode tube 18 is mounted on an outer peripheral side of the inner tube 3 through intermediation of the holding members 11 and 16 provided so as to be separated in the axial direction (vertical direction). The electrode tube 18 surrounds the outer peripheral side of the inner tube 3 over the entire periphery, to thereby form, inside the electrode tube 18, that is, between the inner peripheral side of the electrode tube 18 and the outer peripheral side of the outer tube 3, the annular passage (now passage), that is, the electrode passage 19 serving as the intermediate passage through which the working fluid 2 flows.

The electrode passage 19 always communicates with the rod side oil chamber B via the oil holes 3A thrilled as horizontal holes extending in the radial direction in the inner tube 3. In other words, as illustrated in FIG. 1 with the arrows F indicating the direction of the flow of the working fluid 2, the working fluid 2 flows in the shock absorber 1 from the rod-side oil chamber B to the electrode passage 19 via the oil holes 3A both in the retraction stroke and the extension stroke of the piston 6. When the piston rod 9 moves forward and backward in the inner tube 3 (that is, the retraction stroke and the extension stroke are repeated), the working fluid 2, which has flowed into the electrode passage 19, flows from a top end side toward a bottom end side in the axial direction of the electrode passage 19 as a result of the forward and backward movement. The working fluid 2, which has flowed into the electrode passage 19, flows out from the bottom end side of the electrode tube 18 to the reservoir chamber A via the adjusting valve 21 described later.

Although not shown, a partition member configured to partition (guide the flow of the working fluid 2) the electrode passage 19 through which the working fluid 2 flows may be provided between the inner peripheral side of the electrode tube 18 and the outer peripheral side of the inner tube 3. In other words, the partition member (flow passage forming member) may be provided on an inner peripheral surface of the electrode tube 18 or the outer peripheral surface of the inner tube 3 so as to be non-rotatable relative to the electrode tube 18 or the inner tube 3, and the partition member may be configured to guide the working fluid 2 not only in the axial direction but also in the circumferential direction. As a result, the passage through which the working fluid 2 flows may be formed as one or a plurality of passages (flow passages) having a spiral or meandering shape with a portion extending in the circumferential direction. In this case, the length of the flow passage from the oil holes 3A to the holding-member-side passages 17 can be longer as compared with the passage linearly extending in the axial direction.

The electrode passage 19 applies a resistance to the fluid, that is, the electro-rheological fluid serving as the working fluid 2 caused to flow by the slide of the piston 6 in the outer tube 4 and the inner tube 3. Therefore, the electrode tube 18 is connected to a positive electrode of a battery 20 serving as a power supply, for example, via a high voltage driver (not shown) configured to generate a high voltage. The battery 20 (and the high voltage driver) serves as a voltage supply part (electric field supply part), and the electrode tube 18 serves as an electrode configured to apply electric field (voltage) to the electro-rheological fluid serving as the working fluid 2, which is the fluid in the electrode passage 19, that is, the functional fluid. In this case, both end sides of the electrode tube 18 are electrically insulated by the electrically insulating holding members 11 and 16. Meanwhile, the inner tube 3 is connected to a negative electrode (ground) via the rod guide 10, the bottom valve 13, the bottom cap 5, the outer tube 4, the high voltage driver, and the like.

The high voltage driver is configured to step up a DC voltage output from the battery 20, and supply (output) the stepped-up voltage to the electrode tube 18 based on a command (high voltage command) output from a controller (not shown) configured to variably adjust the damping force of the shock absorber 1. As a result, an electric potential difference in accordance with the voltage applied to the electrode tube 18 is generated between the electrode tube 18 and the inner tube 3, in other words, inside the electrode passage 19, and the viscosity of the working fluid 2, which is the electro-rheological fluid, changes. In this case, the shock absorber 1 is capable of continuously adjusting a characteristic (damping force characteristic) of the generated damping three from a hard characteristic to a soft characteristic in accordance with the voltage applied to the electrode tube 18. The shock absorber 1 may be capable of adjusting the damping three characteristic not continuously but in two steps or a plurality of steps.

Incidentally, in Patent Literature 1, there is disclosed a configuration of causing working fluid, which has passed through an electrode passage between an inner tube and an electrode tube, to directly flow to a reservoir chamber. Now, consideration is made of a case where the damping force characteristic of the shock absorber is adapted to a type, specifications, and the like of a vehicle in which the shock absorber is installed (adapted, to an actual vehicle). In this case, in the configuration of Patent Literature 1, in order to tune (adjust) the damping force characteristic by a method other than the voltage adjustment, it is conceivable, for example, to adjust (change) a size of a gap between the inner tube and the electrode tube in accordance with the type, the specifications, and the like of the vehicle. Further, it is also conceivable to adjust (change) shapes (inclination, length, and the like) of a flow passage forming member provided between the inner tube and the electrode tube in accordance with the type, the specifications, and the like of the vehicle.

However, in this case, it is necessary to prepare the inner tube, the electrode tube, and the flow passage forming member for each of the types and the specifications of the vehicle. As a result, the types of the components increase, and a mass production cost may increase. Meanwhile, it is conceivable to adjust a valve (piston valve) provided in the piston, to thereby tune the damping characteristic. However, in this case, even when the damping characteristic in the retraction stroke may be tuned, it is difficult to tune the damping force characteristic in the extension stroke.

In contrast, in the configuration according to the first embodiment, the working fluid 2, which has passed through the electrode passage 19 between the inner tube 3 and the electrode tube 18, is caused to flow from the first passage (the holding-member-side passages 17, the radial passages 14E, and the annular passage 14F) to the reservoir chamber A via the adjusting valve 21. As a result, the damping force characteristic can be tuned by a method other than the voltage adjustment. Now, description is made of the first passage and the adjusting valve 21 of the first embodiment.

The adjusting valve 21 is a component (damping force adjusting valve) configured to generate the damping force. The adjusting valve 21 is provided in the first passage configured to allow the rod-side oil chamber B and the reservoir chamber A to communicate with each other via the electrode passage 19, more specifically, the first passage configured to allow the electrode passage 19 and the reservoir chamber A to communicate with each other via the bottom valve 13. The first passage includes the holding-member-side passages 17, the radial passages 14E, and the annular passage 14F, and is a passage configured to allow, together with the electrode passage 19, the rod-side oil chamber B and the reservoir chamber A to communicate with each other. Further, the adjusting valve 21 is provided in the first passage of the bottom valve 13, more specifically, on a downstream side (at a downstream end) of the annular passage 14F of the valve body 14. In other words, the adjusting valve 21 is provided to close an opening at the downstream end of the annular passage 14F.

The adjusting valve 21 includes a disc 21A and a plate spring 21B. The disc 21A is provided on a downstream side of the electrode passage 19 and serves as an annular on-off valve (valve body). The plate spring 21B serves as an elastic member for urging the disc 21A. Further, a retainer 22 is provided between the disc 21A and the plate spring 21B. When the plate spring 21B can be omitted, the adjusting valve 21 may be farmed only of the on-off valve, for example, only of a plurality of discs. The disc 21A, the plate spring 21B, and the retainer 22 are sandwiched between the bottom surface of the valve body 14 and the washer 24 through use of a bolt and a nut 23. In the disc 21A, each of through holes 21A1 is farmed at a position opposing each of the oil passages 14A in the valve body 14. The through holes 21A1 are formed so as not to block the working fluid 2 in the reservoir chamber A flowing toward the oil passages 14A in the valve body 14.

When the disc 21A is seated on an opening (peripheral edge) of the annular passage 14F, the annular passage 14F is blocked, and is thus in a closed state. When the disc 21A is separated from the opening (peripheral edge) of the annular passage 14F, the annular passage 14F is in an open state of communicating with the reservoir chamber A. FIG. 1 and FIG. 2 are illustrations of the closed state.

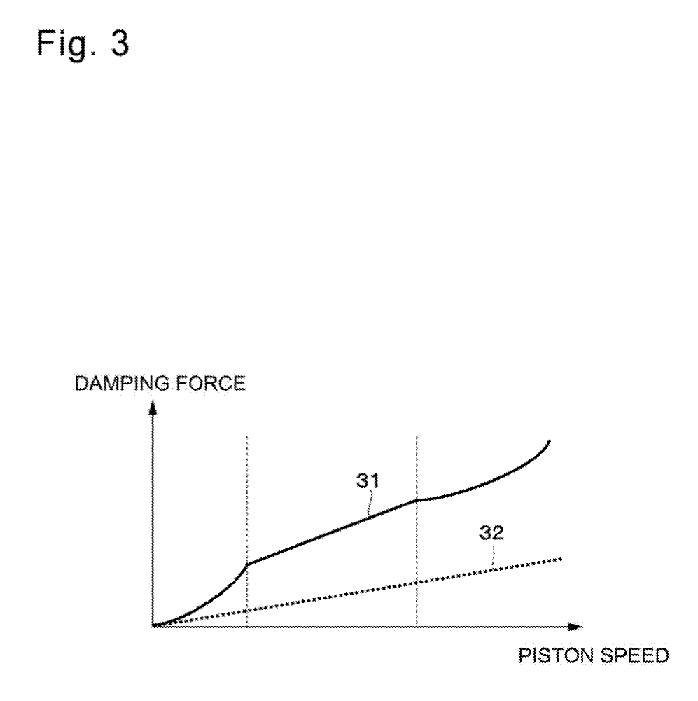

In the first embodiment, for example, the adjusting valve 21 may be adjusted in accordance with the type, the specifications, and the like of the vehicle in which the shock absorber 1 is installed. In other words, an orifice area of the adjusting valve 21, spring stiffness (elastic forces and urging forces) of the disc 21A and the plate spring 21B, and a port area (for example, an opening area of the annular passage 14F of the valve body 14) of the adjusting valve 21 may be adjusted (changed) in accordance with the type, the specifications, and the like of the vehicle in which the shock absorber 1 is installed. FIG. 3 is a graph for showing a relationship between a piston speed and the damping force. A solid characteristic line 31 of FIG. 3 corresponds to a damping three characteristic of the shock absorber 1 in which the adjusting valve 21 is installed. A broken characteristic line 32 of FIG. 3 corresponds to a damping force characteristic of a shock absorber in which the adjusting valve 21 is not installed (the working fluid is caused to directly flow from the electrode passage to the reservoir chamber).

As shown in FIG. 3, the damping force characteristic of the shock absorber 1 can be changed from the characteristic line 32 of FIG. 3 to the characteristic line 31 by providing the adjusting valve 21. In this case, the damping three characteristic in a low piston speed range can be tuned, for example, by adjusting the orifice area. Further, the damping force characteristic in a medium piston speed range can be tuned, for example, by adjusting the spring stiffness. Further, the damping force characteristic in a high piston speed range can be tuned, for example, by adjusting the port area. In other words, the adjusting valve 21 can adjust (change) the damping three in relation with the piston speed. As described above, in the first embodiment, the damping force characteristic of the shock absorber 1 can be tuned as desired by adjusting the adjusting valve 21.

The shock absorber 1 according to the first embodiment has the above-mentioned configuration. Now, description is made of the operation thereof.

When the shock absorber 1 is installed in a vehicle such as an automobile, for example, the top end side of the piston rod 9 is mounted to a body side of the vehicle, and a bottom end side (bottom cap 5 side) of the outer tube 4 is mounted to a wheel side (axle side). When a vibration in the vertical direction is generated due to roughness of a road surface and the like during travel of the vehicle, the piston rod 9 is displaced so as to extend and retract with respect to the outer tube 4. The electric potential difference is generated in the electrode passage 19 based on the command from the controller to control the viscosity of the working fluid 2, that is, the electro-rheological fluid passing through the electrode passage 19, to thereby variably adjust the generated damping force of the shock absorber 1.

For example, in the extension stroke of the piston rod 9, the retraction-side check valve 7 of the piston 6 is closed by the movement of the piston 6 in the inner tube 3. Before the disc valve 8 of the piston 6 is opened, the oil liquid (working fluid 2) in the rod-side oil chamber B is pressurized, and flows into the electrode passage 19 via the oil holes 3A in the inner tube 3. The amount of the oil liquid corresponding to the movement of the piston 6 opens the extension-side check valve 15 of the bottom valve 13, and flows from the reservoir chamber A into the bottom-side oil chamber C.

Meanwhile, in the retraction stroke of the piston rod 9, the retraction-side check valve 7 of the piston 6 is opened by the movement of the piston 6 in the inner tube 3, and the extension-side check valve 15 of the bottom valve 13 is closed. As a result, the oil liquid in the bottom-side oil chamber C flows into the rod-side oil chamber B. Simultaneously, the oil liquid corresponding to an amount of entry of the piston rod 9 into the inner tube 3 flows from the rod-side oil chamber B into the electrode passage 19 via the oil holes 3A in the inner tube 3.

In both cases (both in the extension stroke and the retraction stroke), the oil liquid, which has flowed into the electrode passage 19, passes through the electrode passage 19 toward the outlet side (bottom side) at viscosity in accordance with the electric potential difference (electric potential difference between the electrode tube 18 and the inner tube 3) of the electrode passage 19, and flows from the electrode passage 19 to the reservoir chamber A via the adjusting valve 21. The shock absorber 1 generates a damping force corresponding to the viscosity of the working fluid 2 passing through the electrode passage 19, and a damping three corresponding to the orifice area, the spring stiffness, the port area, and the like of the adjusting valve 21, thereby being capable of absorbing (damping) the vertical vibration of the vehicle.

Thus, in the first embodiment, the adjusting valve 21 configured to generate the damping three is provided in the first passage configured to allow the rod-side oil chamber B and the reservoir chamber A to communicate with each other via the electrode passage 19, specifically, in the annular passage 14F of the valve body 14. Therefore, the shock absorber can obtain the damping force based on the passage of the working fluid 2 through the electrode passage 19 and the damping force based on the passage of the working fluid 2 through the adjusting valve 21. Thus, as shown in FIG. 3, the respective damping force characteristics in the piston low speed range, the piston medium speed range, and the piston high speed range can be tuned as desired by adjusting the orifice area, the spring stiffness, and the port area of the adjusting valve 21. As a result, the damping force characteristics can be tuned as desired by a method other than the adjustment of the damping force through the voltage adjustment when the working fluid 2 passes through the electrode passage 19, thereby being capable of increasing the degree of freedom of the tuning. In other words, a plurality of types of the shock absorber 1 having the damping force characteristics different from one another can be provided by adjusting (setting) the adjusting valve 21 in accordance with the types, the specifications, and the like of the vehicle, thereby being capable or reducing the mass production cost.

In the first embodiment, the adjusting valve 21 includes the disc 21A provided on the downstream side of the electrode passage 19, and the plate spring 21B configured to urge the disc 21A. Therefore, the damping force characteristic can finely be tuned by adjusting the spring stiffness (elastic forces and urging threes) of the disc 21A and/or the plate spring 21B, and the orifice area and the port area of the disc 21A. In this case, the damping force characteristic can be tuned as desired, for example, by only adjusting (changing) the disc 21A. As a result, a component cost can be reduced, and the mass production cost can be reduced also in this respect. Further, the adjusting valve 21 (the disc 21A) is provided on the downstream side of the electrode passage 19. Thus, entry (counter flow) to the electrode passage 19 of high pressure gas in the reservoir chamber A can be prevented. As a result, degradation in insulation property can be prevented.

In the first embodiment, the holding-member-side passages 17, the radial passages 14E, and the annular passage 14F constructing the first passage communicate with the reservoir chamber A via the electrode passage 19 and the bottom valve 13. The adjusting valve 21 is provided in the annular passage 14F of the valve body 14 constructing the bottom valve 13. As a result, the adjusting valve 21 can be built into the valve body 14 of the bottom valve 13 originally provided. As a result, for example, increase in complexity and size of the adjusting valve 21 and increase in the number of components of the adjusting valve 21 can be suppressed.

In the first embodiment, the retraction-side check valve 7 configured to permit only the flow of the working fluid 2 from the bottom-side oil chamber C to the rod-side oil chamber B is provided in the piston 6, and the extension-side check valve 15 configured to permit only the flow of the working fluid 2 from the reservoir chamber A to the bottom-side oil chamber C is provided in the bottom valve 13. Therefore, the damping force characteristic can be tuned in a wider range by providing the adjusting valve 21 in the annular passage 14F of the first passage connected to the outlet side of the electrode passage 19 in the shock absorber 1 having the uni-flow structure.

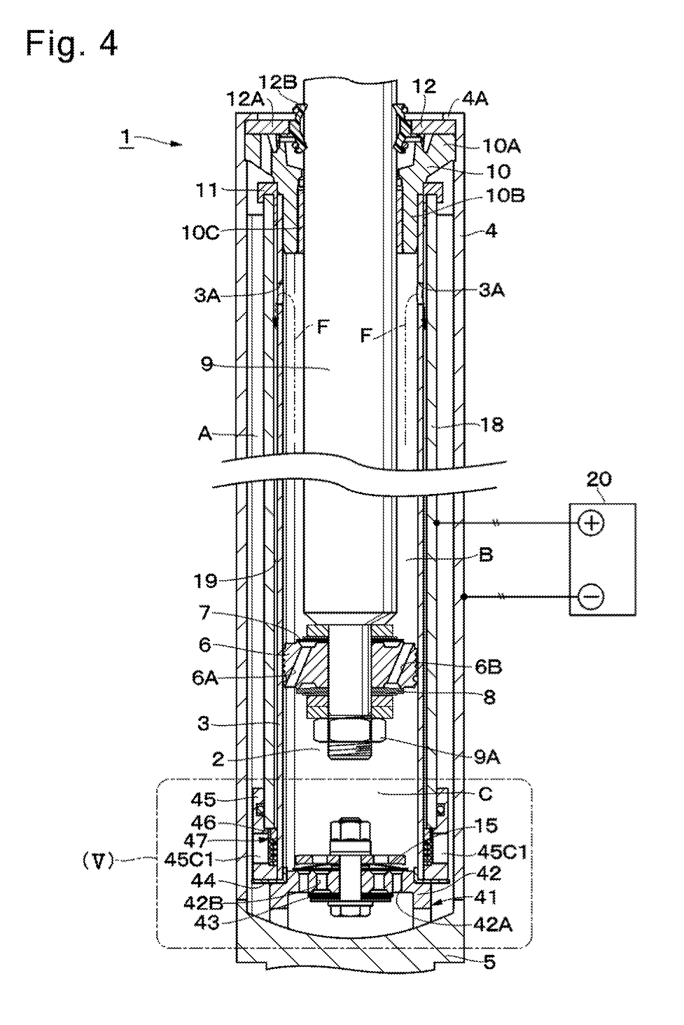

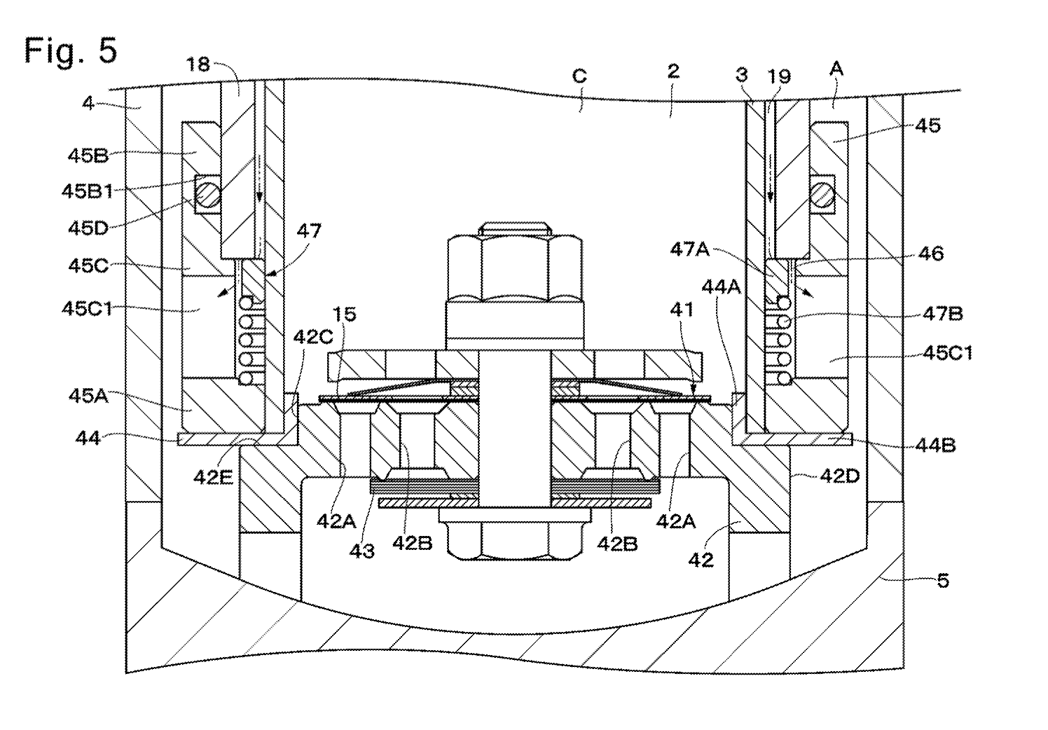

Next, FIG. 4 and FIG. 5 are illustrations of a second embodiment. A feature of the second embodiment is that the adjusting valve is provided between the intermediate tube (electrode tube) and the body valve. In the second embodiment, the same components as those of the first embodiment are denoted by the same symbols, and description thereof is omitted.

A bottom valve 41 serving as the body valve includes a valve body 42, the extension-side cheek valve 15, and a retraction-side disc valve 43. Oil passages 42A and 42B are formed at intervals in the circumferential direction in the valve body 42. A small diameter part 42C positioned on a top side, and a large diameter part 42D positioned on a bottom end side of the small diameter part 42C are formed on an outer peripheral side of the valve body 42. A support ring 44 described later is fixed through fitting to the small diameter part 42C. The large diameter part 42D has a larger diameter than that of the small diameter part 42C. A step part 42E against which a bottom surface of the support ring 44 is held in abutment is formed between the small diameter part 42C and the large diameter part 42D.

The retraction-side disc valve 43 is provided, for example, on a bottom surface side of the valve body 42. In a ease where the pressure in the bottom-side oil chamber C exceeds a relief set pressure when the piston 6 is slid and displaced downward in the retraction stroke of the piston rod 9, the retraction-side disc valve 43 is opened, and relieves the pressure on this occasion to the reservoir chamber A side via the respective oil passages 42B.

The support ring 44 is mounted to the small diameter part 42C of the valve body 42. The support ring 44 is configured to support the bottom end side of the inner tube 3 with respect to the valve body 42, and support the bottom end side of the electrode tube 18 through intermediation of a holding member 45. Therefore, the support ring 44 includes a tube part 44A fitted to the small diameter part 42C of the valve body 42, and a bottom part 44B having a flange shape extending radially outward over an entire periphery from a bottom end side of the tube part 44A. The inner peripheral side of the bottom end of the inner tube 3 is fitted to the inner tube part 44A. The holding member 45 is fitted to the outer peripheral side of the bottom end of the inner tube 3. Further, a valve body 47A and a coil spring 47B of an adjusting valve 47 are arranged between the outer peripheral side of the inner tube 3 and an inner peripheral side of the holding member 45.

The holding member 45 is mounted to the valve body 42 through intermediation of the support ring 44 and the inner tube 3. The holding member 45 holds the bottom end side of the electrode tube 18 while positioning the bottom end side of the electrode tube 18 in the axial direction. The holding member 45 is made of, for example, an electrically insulating material (isolator), and is configured to maintain an electrically insulated state between the inner tube 3 and the electrode tube 18 and between the valve body 42 and the electrode tube 18.

The holding member 45 includes a mounting tube part 45A serving as a first tube part, a support tube part 45B serving as a second tube part, and an intermediate tube part 45C serving as a third tube part. The mounting tube part 45A is fitted to the outer peripheral side of the bottom end of the inner tube 3. The inner diameter of the mounting tube part 45A is the smallest (smaller than the inner diameter of the support tube part 45B and the inner diameter of the intermediate tube part 45C).

Meanwhile, an outer peripheral side of the bottom end of the electrode tube 18 is fitted to the support tube part 45B. The inner diameter of the support tube part 45B is the largest (larger than the inner diameter of the mounting tube part 45A and the inner diameter of the intermediate tube part 45C). A seal groove 45B1 as a circumferential groove is formed over an entire periphery on an inner peripheral surface of the support tube part 45B. A seal member 45D configured to seal, in a liquid-tight manner, a gap between the holding member 45 and the electrode tube 18 is provided in the seal groove 45B1.

The intermediate tube part 45C is provided between the mounting tube part 45A and the support tube part 45B. The inner diameter of the intermediate tube part 45C is larger than the inner diameter of the mounting tube part 45A and is smaller than the inner diameter of the support tube part 45B). The bottom end of the electrode tube 18 is held in abutment against the intermediate tube part 45C. As a result, the intermediate tube part 45C positions the electrode tube 18 in the axial direction. The adjusting valve 47 is provided between an inner peripheral surface of the intermediate tube part 45C and the outer peripheral surface of the inner tube 3. A plurality of radial passages 45C1 extending in the radial direction are formed at intervals in the circumferential direction in the intermediate tube part 45C. Further, the inner diameter of the intermediate tube part 45C is larger than the diameter of the valve body 47A of the adjusting valve 47, and an annular passage 46 extending in the axial direction is formed between the inner peripheral surface of the intermediate tube part 45C and an outer peripheral surface of the valve body 47A.

The annular passage 45 is connected to the radial passages 45C1. In other words, the annular passage 46 and the radial passages 45C1 construct a first passage configured to allow the rod-side oil chamber B and the reservoir chamber A to communicate with each other via the electrode passage 19. In other words, the electrode passage 19 and the reservoir chamber A communicate with each other via the annular passage 46 and the radial passages 45C1.

The adjusting valve 47 is a component configured to generate the damping force. The adjusting valve 47 is provided in the first passage configured to allow the electrode passage 19 and the reservoir chamber A to communicate with each other via the holding member 45. The first passage includes the annular passage 46 and the radial passages 45C1, and is a passage configured to allow, together with the electrode passage 19, the rod-side oil chamber B and the reservoir chamber A to communicate with each other. Further, the adjusting valve 47 is provided in the first passage of the holding member 45, more specifically, on an upstream side (at an upstream end) of the annular passage 46. In other words, the adjusting valve 47 is provided to close an opening at the downstream end of the electrode passage 19.

The adjusting valve 47 includes the valve body 47A and the coil spring 47B. The valve body 47A is provided on the downstream side of the electrode passage 19 and serves as an annular on-off valve. The coil spring 47B serves as an elastic member configured to urge the valve body 47A toward an opening side of the electrode passage 19. When the valve body 47A is seated on an opening of the electrode passage 19 (peripheral edge of the electrode tube 18), the valve is in a closed state of closing the opening of the electrode passage 19. When the valve body 47A is separated from the opening of the electrode passage 19 (peripheral edge of the electrode tube 18), the valve is in an open state of allowing the electrode passage 19 to communicate with the reservoir chamber A. FIG. 4 and FIG. 5 are illustrations of the closed state. In the second embodiment, the damping force characteristic of the shock absorber 1 can be tuned as desired by adjusting an orifice area of the adjusting valve 47, the spring stiffness (elastic force and urging force) of the coil spring 47B, and the like.

The second embodiment provides the above-mentioned adjusting valve 47 between the electrode tube 18 and the bottom valve 41, and a basic action thereof is not particularly different from that of the first embodiment. In particular, in the second embodiment, the adjusting valve 47 can be built into the holding member 45 provided between the valve body 42 of the bottom valve 41 and the electrode tube 18. In this case, the holding member 45 is necessary for supporting the electrode tube 18. Thus, it is possible to prevent increase in the number of components of the adjusting valve 47, and increases in complexity and the size of the adjusting valve 47.

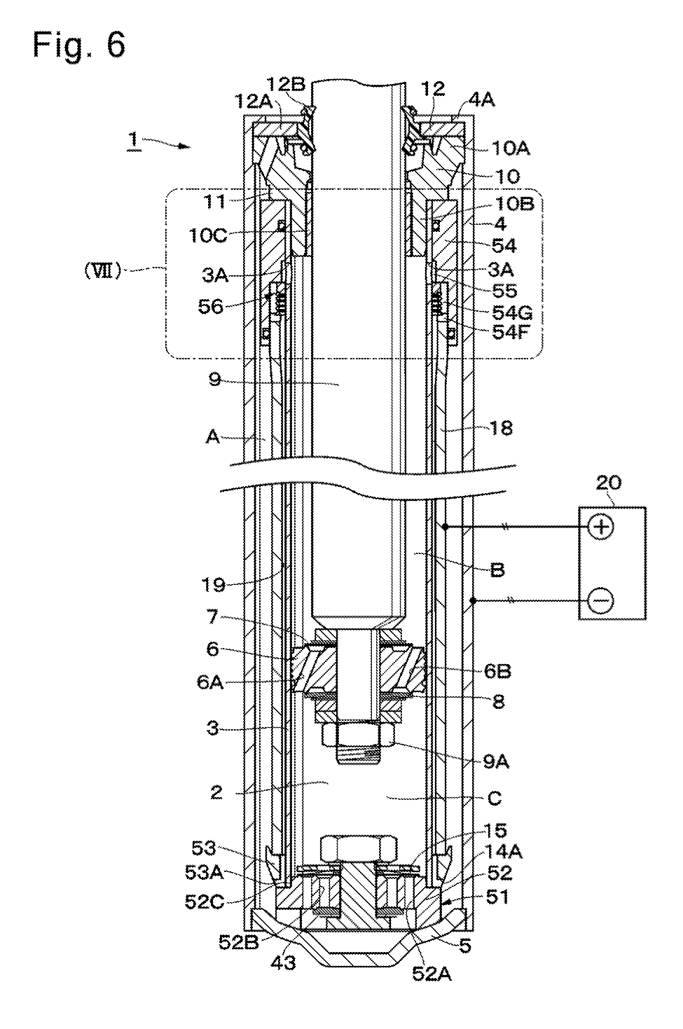

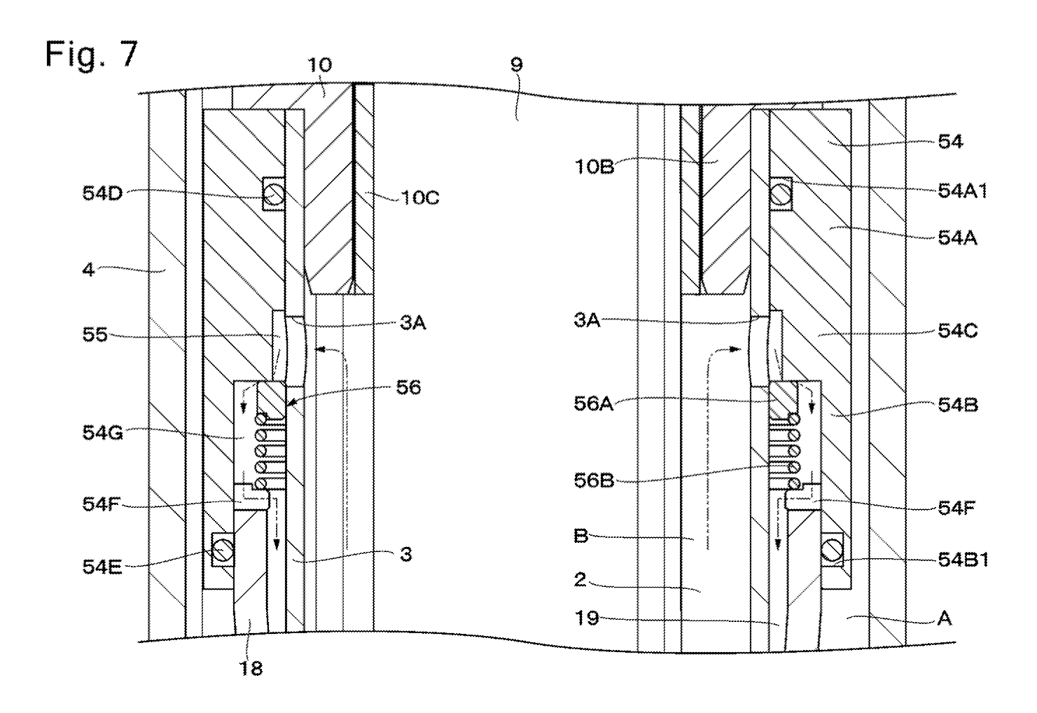

Next, FIG. 6 and FIG. 7 are illustrations of a third embodiment. A feature of the third embodiment is that the adjusting valve is provided on an upstream side of the intermediate passage (electrode passage). In the third embodiment, the same components as those of the first embodiment and the second embodiment are denoted by the same symbols, and description thereof is omitted.

A bottom valve 51 serving as the body valve includes a valve body 52, the extension-side check valve 15, and the retract on-side disc valve 43. Oil passages 52A and 52B are formed at intervals in the circumferential direction in the valve body 52. A step part 52C is formed on an outer peripheral side of the valve body 52, and the inner peripheral side of the bottom end of the inner tube 3 is fixed through fitting to the step part 52C. Further, an annular holding member 53 fixed to the step part 52C while being fitted to the outer peripheral side of the inner tube 3. The holding member 53 is made of, for example, an electrically insulating material (isolator), and holds the bottom end side of the electrode tube 18 while positioning the bottom end side of the electrode tube 1 in the axial direction. A plurality of oil passages 53A configured to allow the electrode passage 19 to communicate with the reservoir chamber A are formed in the holding member 53.

Meanwhile, the top end side of the electrode tube 18 is held by another holding member 54. The holding member 54 is positioned on an outer peripheral side of the small diameter part 10B of the rod guide 10, and is mounted through fitting to an outer peripheral side of a top end of the inner tube 3. The holding member 54 holds the top end side of the electrode tube 18 while positioning the top end side of the electrode tube 18 in the axial direction. The holding member 54 is made of, for example, an electrically insulating material (isolator), and is configured to maintain an electrically insulated state between the inner tube 3 and the electrode tube 18 and between the rod guide 10 and the electrode tube 18.

The holding member 54 includes a mounting tube part 54A serving as a first tube part, a support tube part 54B serving as a second tube part, and an intermediate tube part 54C serving as a third tube part. The mounting tube part 54A is fitted to the outer peripheral side of the top end of the inner tube 3. The inner diameter of the mounting tube part 54A is the smallest (smaller than the inner diameter of the support tube part 54B and the inner diameter of the intermediate tube part 54C). A seal groove 54A1 serving as a circumferential groove is formed over an entire periphery in an inner peripheral surface of the mounting tube part 54A. A seal member 54D configured to seal, in a liquid-tight manner, a gap between the holding member 54 and the inner tube 3 is provided in the seal groove 54A1.

Meanwhile, an outer peripheral side of a top end of the electrode tube 18 is fitted to the support tube part 54B. The inner diameter of the support tube part 54B is the largest (larger than the inner diameter of the mounting tube part 54A and the inner diameter of the intermediate tube part 54C). A seal groove 54B1 serving as a circumferential groove is formed over an entire periphery in an inner peripheral surface of the support tube part 54B. A seal member 54E configured to seal, in a liquid-tight manner, a gap between the holding member 54 and the electrode tube 18 is provided in the seal groove 54B1. A plurality of protruded parts 54F protruding radially inward are provided at intervals in the circumferential direction on the inner peripheral surface of the support tube part 54B. The top end of the electrode tube 18 is held in abutment against each of the protruded parts 54F. As a result, each of the protruded parts 54F of the holding member 54 positions the electrode tube 18 in the axial direction. Further, an adjusting valve 56 is provided between the inner peripheral surface of the support tube part 54B and the outer peripheral surface of the inner tube 3 on an upper side of the respective protruded parts 54F. Further, a gap between the inner peripheral surface of the support tube part 54B and the adjusting valve 56 and gaps between the protruded parts 54F neighboring each other in the circumferential direction form axial passages 54G through which the working fluid 2 flows in the axial direction.

The intermediate tube part 54C is provided between the mounting tube part 54A and the support tube part 54B. The inner diameter of the intermediate tube part 54C is larger than the inner diameter of the mounting tube part 54A and is smaller than the inner diameter of the support tube part 54B. The intermediate tube part 54C is opposed to the oil holes 3A in the inner tube 3. Further, a gap between an inner peripheral surface of the intermediate tube part 54C and the outer peripheral surface of the inner tube 3 forms an annular passage 55 serving as a passage through which the working fluid 2 flows. The annular passage 55 is connected to the axial passages 54G via the adjusting valve 56. In other words, the annular passage 55 and the axial passages 54G form a first passage configured to allow the rod-side oil chamber B and the reservoir chamber A to communicate with each other via the electrode passage 19. In other words, the electrode passage 19 and the rod-side oil chamber B communicate with each other via the annular passage 55 and the axial passages 54G.

The adjusting valve 56 is a component configured to generate the damping force. The adjusting valve 56 is provided in the first passage configured to allow the rod-side oil chamber B to communicate with the electrode passage 19 via the holding member 54. The first passage includes the annular passage 55 and the axial passages 54G, and is a passage configured to allow, together with the electrode passage 19, the rod-side oil chamber B and the reservoir chamber A to communicate with each other. Further, the adjusting valve 56 is provided in the first passage of the holding member 54, more specifically, between the annular passage 55 and the holding member 54. In other words, the adjusting valve 56 is provided to close an opening at the downstream end of the annular passage 55.

The adjusting valve 56 includes a valve body 56A and a coil spring 56B. The valve body 56A is provided on the upstream side of the electrode passage 19 and on the downstream side of the annular passage 55 and serves as an annular on-off valve. The coil spring 56B serves as an elastic member configured to urge the valve body 56A toward an opening side of the annular passage 55. When the valve body 56A is seated on the opening of the annular passage 55 (peripheral edge of the intermediate tube part 54C), the valve is in a closed state of closing the opening of the annular passage 55. When the valve body 56A is separated from the opening of the annular passage 55 (peripheral edge of the intermediate tube part 54C), the valve is in an open state of allowing the annular passage 55 to communicate with, the reservoir chamber A via the electrode passage 19. FIG. 6 and FIG. 7 are illustrations of the closed state. In the third embodiment, the damping force characteristic of the shock absorber 1 can be timed as desired by adjusting an orifice area of the adjusting valve 56, the spring stiffness (elastic force and urging force) of the coil spring 56B, and the like.

The third embodiment provides the above-mentioned adjusting valve 56 between the electrode tube 18 and the rod guide 10, and a basic action thereof is not particularly different from those of the first embodiment and the second embodiment. In particular, in the third embodiment, the adjusting valve 56 is provided on an upstream side of the electrode passage 19, with the result that the working fluid 2 at the high pressure passes through the adjusting valve 56. Therefore, for example, a remarkable change in damping force characteristic through the tuning of the adjusting valve 56 can be attained. Further, the adjusting valve 56 can be built into the holding member 54 provided between the rod guide 10 and the electrode tube 18. In this case, the holding member 54 is necessary for supporting the electrode tube 18. Thus, it is possible to prevent increase in the number of components of the adjusting valve 56, and increases in complexity and the size of the adjusting valve 56.

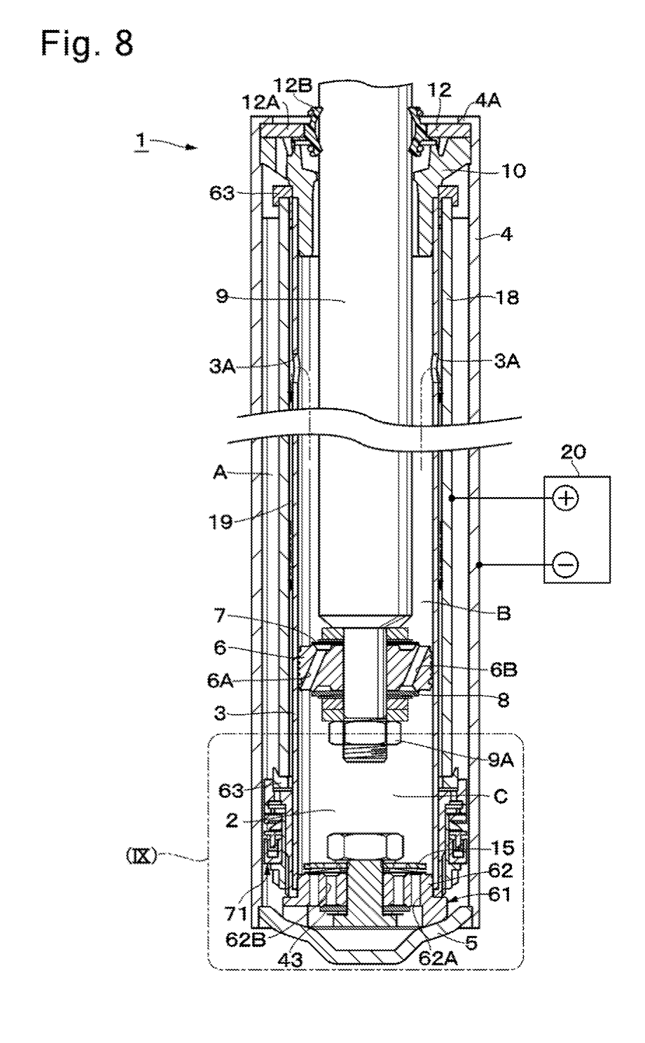

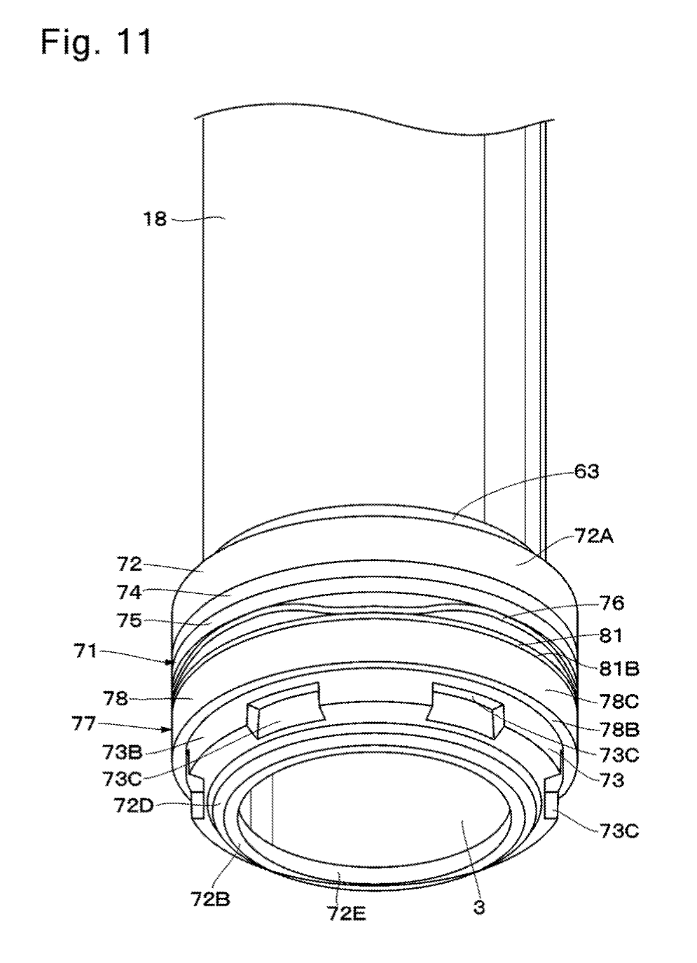

Next, FIG. 8 to FIG. 12 are illustrations of a fourth embodiment. A feature of the fourth embodiment is that the adjusting valve is a damping force adjusting valve having a relief pressure that changes in accordance with a temperature change. In other words, a hydraulic damper disclosed in Patent Literature 2 is configured to change a flow passage area of a damping passage (annular oil passage) of a piston in accordance with the temperature of working fluid in order to suppress a characteristic change (change in damping force) caused by a change in viscosity (flow resistance) of the working fluid in accordance with the temperature change. However, the configuration of Patent Literature 2 changes the cross-sectional area of the annular oil passage in accordance with the temperature of the working fluid, to thereby change the damping force. Thus, the damping force increases in proportion to the cube of the piston speed. In this case, as the piston speed increases (becomes higher), the damping force may become excessive. Thus, an object of the fourth embodiment is to provide a cylinder device (shock absorber) capable of preventing the damping force from becoming excessive.

In FIG. 8, the shock absorber 1 as the cylinder device is constructed as a hydraulic shock absorber (semi-active damper) of the adjustable damping force type employing electro-rheological fluid as the working fluid 2 serving as the working oil. The shock absorber 1 constructs, together with, for example, a spring (such as a coil spring), which is not shown, a suspension device for a vehicle. The shock absorber 1 includes the inner tube 3, the outer tube 4, the piston 6, the piston rod 9, and the electrode passage 19 serving as the oil passage.

The outer tube 4 forms an outer shell of the shock absorber 1, and is formed as a cylindrical body. One end side (bottom end side) of the outer tube 4 is a closed end which is closed by the bottom cap 5 through welding means or the like. Another end side (top end side) of the outer tube 4 is an open end. The crimped part 4A is formed on the open end side of the outer tube 4 by bending the another end side of the outer tube 4 radially inward. The crimped part 4A is configured to hold an outer peripheral side of the annular plate body 12A of the seal member 12 in a state of preventing detachment.

The inner tube 3 is provided coaxially with the outer tube 4 in the outer tube 4. The bottom end side of the inner tube 3 is mounted through fitting to a bottom valve 61. The top end side of the inner tube 3 is mounted through fitting to the rod guide 10. The inner tube 3, together with the outer tube 4, constructs a cylinder, and the working fluid 2 is sealed in the cylinder. Also in the fourth embodiment, as the fluid filled (sealed) in the cylinder, that is, the working fluid 2 serving as the working oil, electro-rheological fluid (ERF) is employed. In FIG. 8 to FIG. 10, the sealed working fluid 2 is colorless and transparent.

A flow resistance (damping three) of the electro-rheological fluid changes in accordance with the applied voltage. Specifically, the electro-rheological fluid is formed of, for example, base oil formed of silicon oil or the like, and particles (particulates), which are mixed with (dispersed in) the base oil, and can change the viscosity in accordance with a change in the electric field. The shock absorber 1 is configured to generate an electric potential difference in the electrode passage 19 described later to control the viscosity of the electro-rheological fluid passing through the electrode passage 19, thereby controlling (adjusting) the generated damping force.

The reservoir chamber A having an annular shape is formed between the outer tube 4 and the inner tube 3 (more specifically, between the outer tube 4 and the electrode tube 18). In the reservoir chamber A, gas is sealed together with the working fluid 2. Examples of the gas may include air at atmospheric pressure and gas such as a compressed nitrogen gas. The gas in the reservoir chamber A is compressed to compensate a volume corresponding to an amount of entry of the piston rod 9 at the time of retraction (retraction stroke) of the piston rod 9.

The piston 6 is fitted (inserted) in the inner tube 3 so as to be slidable. The piston 6 defines the rod-side oil chamber B and the bottom-side oil chamber C in the inner tube 3. The plurality of oil passages 6A and the plurality of oil passages 6B configured to allow communication between the rod-side oil chamber B and the bottom-side oil chamber C are formed in the piston 6 so as to be separated from one another in the circumferential direction.

The retraction-side check valve 7 as a first check valve is provided on a top end surface of the piston 6. The retraction-side check valve 7 is opened, for example, when the piston 6 is slid and displaced downward in the inner tube 3 in the retraction stroke of the piston rod 9, and is closed otherwise. The retraction-side check valve 7 is configured to allow the oil liquid (working fluid 2) in the bottom-side oil chamber C to flow through each of the oil passages 6A toward the rod-side oil chamber B, and block a flow of the oil liquid in an opposite direction.

For example, the extension-side disc valve 8 is provided on a bottom end surface of the piston 6. In a ease where a pressure in the rod-side oil chamber B exceeds a relief set pressure when the piston 6 is slid and displaced upward in the extension stroke of the piston rod 9, the disc valve 8 is opened, and relieves the pressure on this occasion to the bottom-side oil chamber C side via the respective oil passages 6B.

The piston rod 9 extends in an axial direction in the inner tube 3 (the same direction as a center axis of the inner tube 3 and the outer tube 4, consequently a center axis of the shock absorber 1, and a vertical direction of FIG. 8 to FIG. 11). In other words, the piston rod 9 is coupled to the piston 6, and extends to the outside of the inner tube 3 and the outer tube 4 that construct the cylinder. In this case, the piston 6 is fixed (fastened) to the bottom end side of the piston rod 9, which is one end side thereof, through use of the nut 9A or the like. Meanwhile, a top end side of the piston rod 9, which is another end side thereof, protrudes to the outside via the rod guide 10. The bottom end of the piston rod 9 may be further extended, and may be protruded outward from a bottom part (for example, the bottom cap 5). Thus, a so-called double-rod cylinder may be formed.

The rod guide 10 having a stepped cylindrical shape is provided through fitting on the top end side (another end side) of the inner tube 3. The rod guide 10 is configured to position a top-side portion of the inner tube 3 and a top-side portion of the electrode tube 18 described later at a center of the outer tube 4. In addition, the rod guide 10 is configured to guide the piston rod 9 so as to allow the piston rod 9 to slide in the axial direction on an inner peripheral side of the rod guide 10.

The annular seal member 12 is provided between the rod guide 10 and the crimped part 4A of the outer tube 4. The seal member 12 includes the metal annular plate body 12A having a hole formed at a center lo allow the piston rod 9 to be inserted therethrough, and the elastic body 12B made of an elastic material, for example, rubber, and fixed to the annular plate body 12A through vulcanization bonding or the like. An inner periphery of the elastic body 12B of the seal member 12 is held in slide-contact with an outer peripheral side of the piston rod 9, thereby scaling a gap between the piston rod 9 and the seal member 12 in a liquid-tight and air-tight manner.

The bottom valve 61 is provided on a bottom end side (one end side) of the inner tube 3 at a position between the inner tube 3 and the bottom cap 5. The bottom valve 61 includes a valve body 62, the extension-side check valve 15, and the disc valve 43. The valve body 62 defines the reservoir chamber A and the bottom-side oil chamber C between the bottom cap 5 and the inner lube 3. Oil passages 62A and 62B configured to allow the communication between the reservoir chamber A and the bottom-side oil chamber C are formed at intervals in the circumferential direction in the valve body 62.

The extension-side check valve 15 is provided, for example, on a top surface side of the valve body 62. The extension-side check valve 15 is opened when the piston 6 is slid and displaced upward in the extension stroke of the piston rod 9, and is closed otherwise. The extension-side check valve 15 is configured to allow the oil liquid (working fluid 2) in the reservoir chamber A to flow through each of the oil passages 62A toward the bottom-side oil chamber C, and block a flow of the oil liquid in an opposite direction.

The retraction-side disc valve 43 is provided, for example, on a bottom surface side of the valve body 62. In a case where the pressure in the bottom-side oil chamber C exceeds a relief set pressure when the piston 6 is slid and displaced downward in the retraction stroke of the piston rod 9, the retraction-side disc valve 43 is opened, and relieves the pressure on this occasion to the reservoir chamber A side via the respective oil passages 62B.

The electrode tube 18 serving as the intermediate tube is provided between the outer tube 4 and the inner tube 3. The electrode tube 18 is provided on the outer peripheral side of the inner tube 3 through intermediation of, for example, the tubular isolators (insulation members) 63 and 63 serving as the holding members provided so as to be separated in the axial direction (vertical direction). The electrode tube 18 internally forms the annular electrode passage 19 extending so as to surround the outer peripheral side of the inner tube 3 over an entire periphery. The electrode passage 19 always communicates with the rod-side oil chamber B via the oil holes 3A formed as horizontal holes extending in the radial direction in the inner tube 3. In other words, as illustrated in FIG. 8 with arrows indicating the direction of the flow of the working fluid 2, the shock absorber 1 has such a uni-flow structure that the working fluid 2 flows from the rod-side oil chamber B to the electrode passage 19 via the oil holes 3A both in the retraction stroke and the extension stroke of the piston 6. The working fluid 2, which has flowed into the electrode passage 19, returns to the reservoir chamber A via a damping force adjusting valve 71 described later.

The electrode passage 19 applies a resistance to the fluid, that is, the electro-rheological fluid serving as the working fluid 2 caused to flow by the slide of the piston 6 in the outer tube 4 and the inner tube 3. Therefore, the electrode tube 18 is connected to the positive electrode of the battery 20 serving as the power supply, for example, via a high voltage driver (not shown) configured to generate a high voltage. The electrode tube 18 serves as an electrode configured to apply electric field to the working fluid 2, which is the fluid in the electrode passage 19, that is, the electro-rheological fluid. In this case, the electrode tube 18 is insulated by the pair of isolators 63 and 63. Meanwhile, the inner tube 3 is connected to a negative electrode (ground) via the rod guide 10, the bottom valve 61, the bottom cap 5, the outer tube 4, the high voltage driver, and the like.

The high voltage driver is configured to step up a DC voltage output from the battery 20, and supply (output) the stepped-up voltage to the electrode tube 18 based on a command (high voltage command) output from a controller (not shown) configured to variably adjust the damping force of the shock absorber 1. As a result, an electric potential difference in accordance with the voltage applied to the electrode tube 18 is generated between the electrode tube 18 and the inner tube 3, in other words, inside the electrode passage 19, and the viscosity of the electro-rheological fluid changes. In this case, the shock absorber 1 is capable of continuously adjusting a characteristic damping force characteristic) of the generated damping force from a hard characteristic to a soft characteristic in accordance with the voltage applied to the electrode tube 18. The shock absorber 1 may be capable of adjusting the damping force characteristic not continuously but in two steps or a plurality of steps.

Incidentally, the electro-rheological fluid employs, for example, silicon oil as base oil, and thus has a larger viscosity change with respect to the temperature as compared with working fluid employing mineral oil as base oil. Specifically, the electro-rheological fluid has high viscosity at low temperature, and low viscosity at high temperature. Therefore, when the temperature of the electro-rheological fluid increases, even when the same electric potential difference is applied by the controller, the viscosity of the electro-rheological fluid decreases, and the damping force may decrease. In other words, when the electro-rheological fluid is employed as the working fluid 2, and any particular measures are not taken, there is a fear in that the characteristic of the damping force of the shock absorber 1 significantly changes due to the change in viscosity of the electro-rheological fluid resulting from the temperature change.

In contrast, a hydraulic damper disclosed in Patent Literature 1 is configured to change a flow passage area of a damping passage (annular oil passage of a piston in accordance with the temperature of the working fluid in order to suppress a characteristic change (change in damping force) caused by the temperature change. However, in this configuration, the damping force increases in proportion to the cube of the piston speed. Thus, the damping force may become excessive as the piston speed increases (become higher).

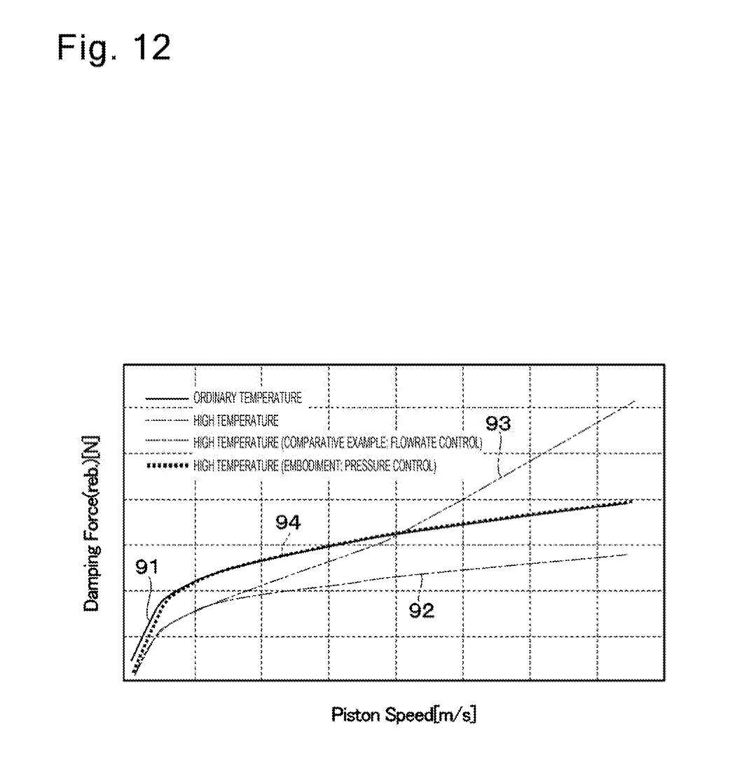

FIG. 12 is a characteristic line graph for showing the relationship between the piston speed and the damping force. In FIG. 12, a solid characteristic line 91 indicates a characteristic at an ordinary temperature (for example, standard temperature). In contrast, a characteristic line 92 as a long dashed short dashed line of FIG. 12 indicates a characteristic which is given when the temperature of the electro-rheological fluid increases. When the temperature of the electro-rheological fluid increases, the viscosity decreases, with the result that the damping force decreases from that at the ordinary temperature. Meanwhile, a characteristic line 93 as a two-dot chain line of FIG. 12 indicates a characteristic which is given when the temperature of the electro-rheological fluid increases in a configuration of controlling the flow rate in accordance with the temperature, that is, a configuration of changing the flow passage area of the annular oil passage of the piston in accordance with the temperature. In this case, as the piston speed increases (becomes higher), the damping force becomes excessive.

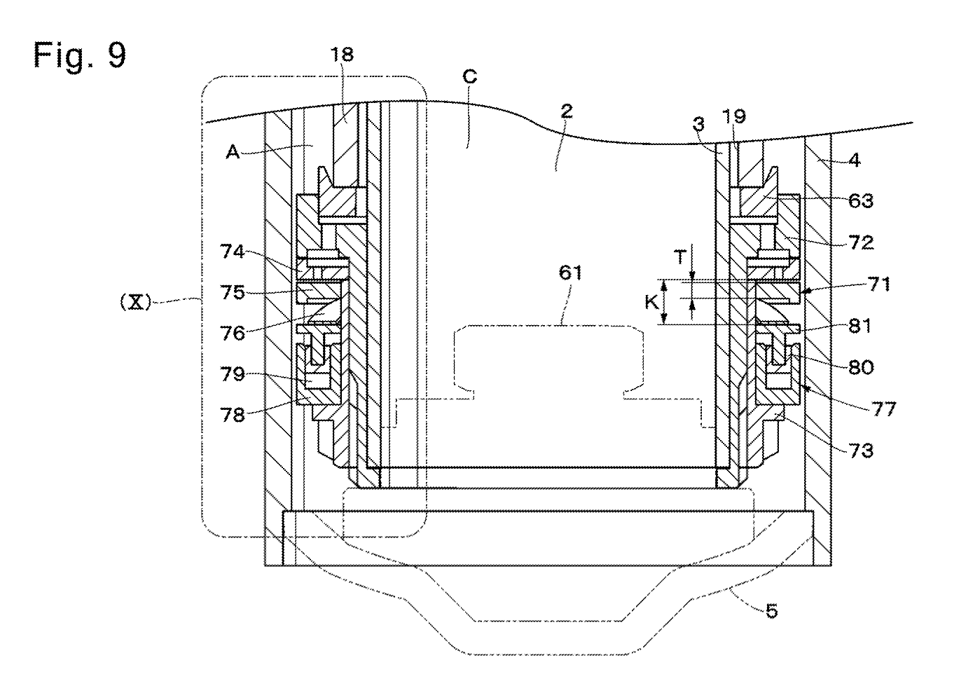

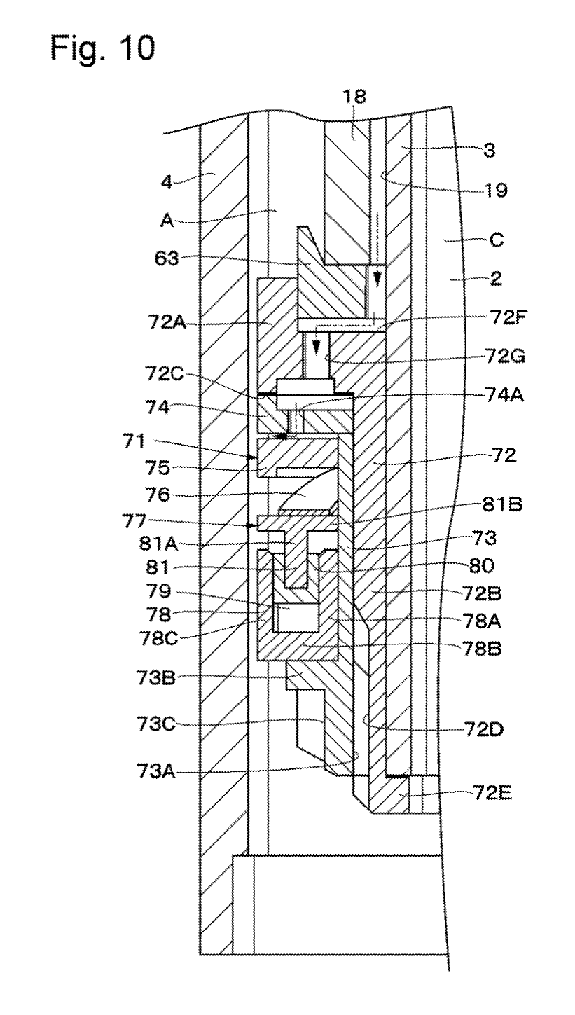

Thus, in the fourth embodiment, the damping force adjusting valve 71 configured to change the relief pressure in accordance with the temperature change is provided in the electrode passage 19 between the inner tube 3 and the electrode tube 18. The damping force adjusting valve 71 serving as the adjusting valve is configured to compensate the change in damping force caused by the temperature change in the electro-rheological which is the working fluid 2. Now, with reference to FIG. 9 to FIG. 11 in addition to FIG. 8, description is made of the damping force adjusting valve 71. In FIG. 9, the bottom cap 5 and the bottom valve 61 are indicated by two-dot chain lines. In FIG. 10, the bottom cap 5 and the bottom valve 61 are omitted.

The damping force adjusting valve 71 is positioned on the bottom end side of the electrode tube 18, which is one end side thereof, and is provided between the electrode tube 18 and the bottom valve 61. In other words, the damping force adjusting valve 71 is provided between the electrode tube 18 and the inner tube 3, and around the one end side (bottom end side) of the inner tube 3, which is an opposite side of the oil holes 3A in the inner tube 3. As a result, the damping force adjusting valve 71 is provided on the downstream side (downstream end) of the annular electrode passage 19 between the inner tube 3 and the electrode tube 18 in series with the electrode passage 19.

The damping force adjusting valve 71 is constructed as a slide valve mechanism in which a set load of a wave washer 76 is variable in accordance with the temperature. In other words, the damping force adjusting valve 71 is configured to change the relief pressure by changing the set load of the wave washer 76, which serves as a spring provided for the damping force adjusting valve 71, through a volume change in a high-cub member 79, which is a member having a high cubical expansion coefficient in accordance with the temperature change, to thereby adjust the generated damping force.

Therefore, the damping force adjusting valve 71 includes a base ring 72, a lock ring 73, a valve seat 74, a slide valve 75, the wave washer 76, and an urging three adjusting device 77. In this case, the damping force adjusting valve 71 serves as an adjusting valve configured to generate a damping three through the slide valve 75 and the wave washer 76.

The base ring 72 is formed into a stepped annular shape. The base ring 72 includes a large diameter part 72A having a large outer diameter dimension, and a small diameter part 72B having an outer diameter dimension smaller than that of the large diameter part 72A. An outer peripheral surface of the large diameter part 72A and an outer peripheral surface of the small diameter part 72B are continuous with each other via a step surface 72C. The bottom end side of the inner tube 3 is fitted to an inside of the base ring 72.

A male thread part 72D configured to threadedly engage the lock ring 73 is formed on one end side (bottom end side) of the base ring 72, that is, a distal end side of the small diameter part 72B. The distal end of the small diameter part 72B is formed as a flange part 72E protruding radially inward over an entire periphery. The flange part 72E of the base ring 72 is sandwiched between the one end (bottom end) of the inner tube 3 and the bottom valve 61 in the axial direction. The bottom valve 61 is press-fitted to the inner tube 3.

A recessed part 72F which is recessed toward the one end side (bottom end side) is formed over an entire periphery on another end side of the base ring 72, that is, another end side (top end side) of the large diameter part 72A. The isolator 63 is mounted through filling into the recessed part 72F. A plurality of outlet oil passages 72G which pass between a bottom surface of the recessed part 72F and the step surface 72C are formed at intervals in the circumferential direction in the large diameter part 72A. As indicated by arrows of FIG. 10, the working fluid 2, that is, the electro-rheological fluid, which has passed between an inner peripheral surface of the isolator 63 and the outer peripheral surface of the inner tube 3, flows from the electrode passage 19 into the respective outlet oil passages 72G.

The base ring 72 and the inner tube 3 are sandwiched by the bottom valve 61 and the rod guide 10 in the axial direction. In addition, the electrode tube 18 is also sandwiched through intermediation of one (bottom) isolator 63 and another (top) isolator 63 between the base ring 72 and the rod guide 10 in the axial direction. Further, the bottom valve 61 and the rod guide 10, together with the seal member 12, are sandwiched between the crimped part 4A of the outer tube 4 and the bottom cap 5 in the axial direction under the state in which the base ring 72, the inner tube 3, the pair of isolators 63 and 63, and the electrode tube 18 are sandwiched in the axial direction.

The lock ring 73 is threadedly mounted to the male thread part 72D of the base ring 72. The lock ring 73 is formed into an approximately cylindrical shape, and an inner peripheral side on a bottom end side, which is one end side, is formed as a female thread part 73A threadedly engaging with the male thread part 72D of the base ring 72. The bottom end side of the lock ring 73 is formed as a flange part 73B protruding radially outward over an entire periphery.

A plurality of recessed pans 73C are formed at intervals in the circumferential direction in the flange part 73B. A protruded part of a tool (not shown) for rotating the lock ring 73 is engaged with each of the recessed, parts 73C. In other words, the lock ring 73 can be mounted to and dismounted from the base ring 72 by rotating the lock ring 73 under a state in which the protruded part of the tool and the recessed pan 73 are engaged with each other.

A top end side (top end surface) of the lock ring 73, which is another end side (another end surface) thereof, is held in abutment against a side surface on an inner diameter side of the valve seat 74, thereby pressing the valve seat 74 toward the step surface 72C of the base ring 72. In other words, the lock ring 73, together with the step surface 72C of the base ring 72, sandwiches the valve seat 74 in the axial direction.

The urging three adjusting device 77, the wave washer 76, and the slide valve 75 are provided in a sequence starting from the flange part 73B between the flange part 73B and the valve seat 74 on an outer peripheral side of the lock ring 73. The urging force adjusting device 77, the wave washer 76, and the slide valve 75 are fitted to the lock ring 73 on the another end side (top end side) with respect to the flange part 73B. In this case, the slide valve 75, the wave washer 76, and a slide ring 81 of the urging force adjusting device 77 are fitted to the lock ring 73 so as to be movable (slidable) in the axial direction (for example, with a gap).

The valve seat 74 is formed into an annular shape. The slide valve 75 is seated on and separated from a side surface (bottom surface) of the valve seat 74. A plurality of outflow holes 74A passing through the valve seat 74 in the axial direction are formed at intervals in the circumferential direction in the valve seat 74. As indicated by the arrows of FIG. 10, the working fluid 2, that is the electro-rheological fluid from the electrode passage 19 flows from the respective outflow holes 74A toward the reservoir chamber A.

When the slide valve 75 is seated on the valve seat 74, the valve is in a closed state of blocking the respective outflow holes 74A. When the slide valve 75 is separated from the valve seat 74, the valve is in an open state of allowing the respective outflow holes 74A to communicate with the reservoir chamber A. FIG. 8 to FIG. 10 are illustrations of the open state.

The slide valve 75 is formed as an annular valve body (on-off valve). The slide valve 75 is pressed against the valve seat 74 by an urging force (urging force in the vertical direction, which corresponds to the axial direction) of the wave washer 76. In other words, the slide vale 75 is pressed against the valve seat 74 at a relief pressure (valve opening pressure) corresponding to the urging force of the wave washer 76.

The slide valve 75 is opened (relieves the pressure) when the pressure of the working fluid 2 that is about to flow from the respective outflow holes 74A toward the reservoir chamber A exceeds a relief pressure corresponding to the urging force of the wave washer 76. The slide valve 751 applies a flow resistance corresponding to the urging force of the wave washer 76 to the oil liquid (working fluid 2) flowing through the respective outflow holes 74A, thereby generating the damping, force.

The wave washer 76 serving as a spring (elastic member) is provided between the slide valve 75 and the slide ring 81 of the urging force adjusting device 77. The wave washer 76 is also referred to as a wave spring, and is formed as an annular compression spring configured to apply the axial urging force. The wave washer 76 serves as a slide valve spring of the slide valve 75.

The wave washer 76 is configured to apply the urging force to the slide valve 75 in a valve closing direction (direction of pressing the slide valve 75 against the valve seat 74). Conversely, the load (set load) of the wave washer 76 is applied in the valve closing direction to the slide valve 75.

The urging force of the wave washer 76 is changed by the urging force adjusting device 77. In other words, the urging force (pressing force of pressing the slide valve 75 in the valve closing direction, that is, the set load) of the wave washer 76 changes in accordance with the position of the slide ring 81 of the urging force adjusting device 77, that is, an interval (separation distance) K between the slide ring 81 and the valve seat 74.

In the fourth embodiment, for example, a value (clearance) obtained by subtracting a thickness dimension (axial dimension) T of the slide valve 75 from the interval K between the slide ring 81 and the valve seat 74 at the ordinary temperature is set to be smaller than a thickness dimension (axial dimension) of the wave washer 76 in a free state. In other words, in the fourth embodiment, there is provided a configuration of applying the set load of the wave washer 76 even at the ordinary temperature (set load is larger than 0 at the ordinary temperature).

The urging force adjusting device 77 is configured to change the set load of the wave washer 76 in accordance with the temperature, to thereby change the relief pressure of the slide valve 75. The urging force adjusting device 77 includes a housing 78, the high-cubical-expansion-coefficient member 79, a seal member 80, and the slide ring 81. The urging force adjusting device 77 can be constructed as a slide ring assembly by integrating the housing 78, the high-cubical-expansion-coefficient member 79, the seal member 80, and the slide ring 81 into one assembly.

The housing 78 is formed as an annular box member having a U-shaped longitudinal section. In other words, the housing 78 includes an inner peripheral part 78A to be fitted to the lock ring 73, a bottom part 78B extending radially outward from the inner peripheral part 78A over an entire periphery, and an outer peripheral part 78C extending in the axial direction from an outer diameter side of the bottom part 78B in parallel with the inner peripheral part 78A. The housing 78 is fitted to the lock ring 73. The bottom part 78B thereof is held in abutment against the flange part 73B of the lock ring 73. An opening side of the housing 78 is blocked by the seal member 80 under a state in which the housing 78 accommodates the high-cubical-expansion-coefficient member 79 therein.

The high-cubical-expansion-coefficient member 79 is sealed in the housing 78 while sealed by the seal member 80. The high-cubical-expansion-coefficient member 79 is a member having the volume that changes in accordance with the temperature, more specifically, a member having a high cubical expansion coefficient in accordance with the temperature. The high-cubical-expansion-coefficient member 79 may be formed of, for example, paraffin wax. When the volume of the high-cubical-expansion-coefficient member 79 changes in accordance with the temperature, a position of the slide ring 81 changes.

For example, when the high-cubical-expansion-coefficient member 79 expands (the volume increases) as a result of increase in the temperature, the interval (separation distance) K between the slide ring 81 and the valve seat 74 decreases, and the urging force of the wave washer 76 consequently increases. Meanwhile, when the high-cubical-expansion-coefficient member 79 contracts (the volume decreases) as a result of decrease in the temperature, the interval (separation distance) K between the slide ring 81 and the valve seat 74 increases, and the urging force of the wave washer 76 consequently decreases. As a result, the preload (initial load or set load) of the wave washer 76 can change in accordance with the temperature (as the temperature changes), and the relief pressure slide valve 75 can be changed.

The seal member 80 is configured to support the slide ring 81 so as to enable the slide ring 81 to move with respect to the housing 78, and seals the high-cubical-expansion-coefficient member 79 in the housing 78. The seal member 80 may be formed of an elastic member, for example, elastomer such as rubber excellent in oil resistance and heat resistance. The seal member 80 nips, in the radial direction, a cylindrical part 81A of the slide ring 81 between the inner peripheral part 78A and the outer peripheral part 78C of the housing 78.

The slide ring 81 is formed into an annular shape as a whole, and is fitted to the housing 78 through intermediation of the seal member 80. The slide ring includes the cylindrical part 81A extending in the axial direction, and a spring press 81B that has a circular ring shape and is provided on another end side (top end side) of the cylindrical part 81A. The wave washer 76 is mounted between the spring pressing part 81B and the slide valve 75 while the spring pressing part 81B is used as a seat surface.

The slide ring 81 moves in the vertical direction, which is the axial direction, as a result of the change in volume of the high-cubical-expansion-coefficient member 79 in accordance with the temperature. When the slide ring 81 moves, a compression amount of the wave washer 76 compressed between the spring pressing part 81B of the slide ring 81 and the slide valve 75 in the axial direction changes, and the set load of the wave washer 76 applied to the slide valve 75 thus changes. As a result, a differential pressure (relief pressure) between the electrode passage 19 and the reservoir chamber A changes, thereby being capable of adjusting the damping three.

The shock absorber 1 according to the fourth embodiment has the above-mentioned configuration. Next, description is made of the operation thereof.

When the shock absorber 1 is installed in a vehicle such as an automobile, for example, the top end side of the piston rod 9 is mounted to a body side of the vehicle, and a bottom end side (bottom cap 5 side) of the outer tube 4 is mounted to a wheel side (axle side). When a vibration in the vertical direction is generated due to roughness of a road surface and the like during travel of the vehicle, the piston rod 9 is displaced so as to extend and retract with respect to the outer tube 4. The electric potential difference is generated in the electrode passage 19 based on the command from the controller to control the viscosity of the working fluid 2, that is, the electro-rheological fluid passing through the oil passage, to thereby variably adjust the generated damping three of the shock absorber 1.

For example, in the extension stroke of the piston rod 9, the retraction-side check valve 7 of the piston 6 is closed by the movement of the piston 6 in the inner tube 3. Before the disc valve 8 of the piston 6 is opened, the oil liquid (working fluid 2) in the rod-side oil chamber B is pressurized, and flows into the electrode passage 19 via the oil holes 3A in the inner tube 3. The amount of the oil liquid corresponding to the movement of the piston 6 opens the extension-side check valve 15 of the bottom valve 13, and flows from the reservoir chamber A into the bottom-side oil chamber C.

Meanwhile, in the retraction stroke of the piston rod 9, the retraction-side check valve 7 of the piston 6 is opened by the movement of the piston 6 in the inner tube 3, and the extension-side check valve 15 of the bottom valve 13 is closed. Before the bottom valve 61 (disc valve 43) is opened, the oil liquid in the bottom-side oil chamber C flows into the rod-side oil chamber B. Simultaneously, the oil liquid corresponding to an amount of entry of the piston rod 9 into the inner tube 3 flows from the rod-side oil chamber B into the electrode passage 19 via the oil holes 3A in the inner tube 3.

In both cases (both in the extension stroke and the retraction stroke), the oil liquid, which has flowed into the electrode passage 19, passes through the electrode passage 19 toward the outlet side (bottom side) at viscosity in accordance with the electric potential difference of the electrode passage 19, and flows from the electrode passage 19 to the reservoir chamber A via the damping three adjusting valve 71. The shock absorber 1 generates a damping force corresponding to the viscosity of the oil liquid passing through the electrode passage 19, and a damping force corresponding to the relief pressure (valve opening pressure) of the damping force adjusting, valve 71, thereby being capable of absorbing (damping) the vertical vibration of the vehicle.

When the temperature of the working fluid 2, which is a working flow, that is, the electro-rheological fluid increases as a result of a change in ambient temperature or a continuous operation of the shock absorber 1, even when the same electric potential difference is applied by the controller, the viscosity of the electro-rheological fluid decreases, and the damping three thus decreases. In contrast, the volume of the high-cubical-expansion-coefficient member 79 of the urging three adjusting device 77 of the damping force adjusting valve 71 increases as the temperature increases, and the slide ring 81 thus moves in a direction of pushing out the slide ring 81 from the housing 78. As a result, the axial compression amount of the wave washer 76 increases, and not only the set load applied to the slide valve 75 but also the relief pressure increase, with the result that the generated damping force of the damping force adjusting valve 71 increases. Consequently, the decrease in the damping force caused by the decrease in the viscosity of the electro-rheological fluid can be cancelled out by the increase in the generated damping force resulting from the increase in the relief pressure of the damping face adjusting valve 71.

Meanwhile, when the temperature of the electro-rheological fluid decreases, the volume of the high-cubical-expansion-coefficient member 79 decreases, and the slide ring 81 thus moves in a direction of accommodating the slide ring 81 in the housing 78. As a result, the compression amount of the wave washer 76 decreases, and not only the set load applied to the slide valve 75 but also the relief pressure decrease, with the result that the generated damping three of the damping force adjusting valve 71 decreases. The viscosity of the electro-rheological fluid increases as a result of the decrease in the temperature, but the generated damping force in total does not change.

As a result, when the same electric potential difference is applied to the electrode passage 19 by the controller, the total damping force of the entire shock absorber 1 can be the same regardless of the temperature change. In other words, a characteristic line 94 indicated by the broken line of FIG. 12 is the characteristic of the fourth embodiment when the temperature of the electro-rheological fluid increases. Even when the temperature increases, the damping force characteristic can be the same as that when the temperature is the ordinary temperature.

In this way, in the fourth embodiment, the change (characteristic change in the shock absorber 1) in the damping force characteristic caused by the temperature change in the electro-rheological fluid can be suppressed. In particular, even when the speed of the piston 6 increases (becomes higher), the damping force can be prevented from becoming excessive.

In other words, in the fourth embodiment, the shock absorber 1 includes the damping three adjusting valve 71 configured to change the relief pressure in accordance with the temperature change in addition to the electrode passage 19 configured to generate the electric potential difference. Therefore, the shock absorber 1 can obtain the damping force based on the passage of the electro-rheological fluid serving as the working fluid 2 through the electrode passage 19 and the damping force based on the passage of the electro-rheological fluid through the damping force adjusting valve 71. As a result, the characteristic change (change in damping force) in the entire shock absorber 1 caused by the temperature change in the electro-rheological fluid can be suppressed (compensated) by the change in relief pressure of the damping force adjusting valve 71. In this case, the damping force adjusting valve 71 is configured to adjust the damping three through the change not only in the set load of the wave washer 76 but also in the relief pressure of the slide valve 75 in accordance with the temperature, thereby being capable of adjusting the damping force independently of the speed of the piston 6. In other words, the damping force can be adjusted as desired regardless of the speed of the piston 6. As a result, even when the speed of the piston 6 becomes higher, the damping force can be prevented from becoming excessive.

The fourth embodiment is configured to provide the damping force adjusting valve 71 in series with the electrode passage 19. Therefore, the damping three of the entire shock absorber 1 can be the sum of the damping force based on the passage of the electro-rheological fluid through the electrode passage 19 and the damping three based on the passage of the electro-rheological fluid through the damping force adjusting valve 71. In other words, the decrease in the damping force resulting from the decrease in the viscosity of the electro-rheological fluid caused by the temperature increase can be cancelled out based on the increase in the damping force resulting from the increase in the relief pressure of the damping force adjusting valve 71 caused by the temperature increase. As a result, also in this respect, the characteristic change (change in damping force) in the entire shock absorber 1 caused by the temperature change in the electro-rheological fluid can be suppressed (compensated).

In the fourth embodiment, description is made of, as an example, the ease of the configuration of applying the set load of the wave washer 76 even at the ordinary temperature (for example, the standard temperature) (the configuration in which the set load at the ordinary temperature is more than 0). However, the present invention is not limited to this example, and there may be provided, for example, a configuration in which the set load of the wave washer 76 is 0 at the ordinary temperature (the set load is not applied). In other words, the value (clearance) obtained by subtracting the thickness dimension (axial dimension) T of the slide valve 75 from the interval K between the slide ring 81 and the valve seat 74 at the ordinary temperature may be set to be larger than the thickness dimension (axial dimension) of the wave washer 76 in the free state. In other words, the relationship between the value obtained by subtracting the thickness dimension T from the interval K at the ordinary temperature and the thickness dimension of the wave washer 76 may be set as appropriate in accordance with the specifications and the like of the shock absorber 1 so as to obtain the required damping force. In other words, the set load (relief pressure) of the damping force adjusting valve is set so as to obtain the desired performance.

In the fourth embodiment, description is made of, as an example, the case where the side surface (bottom surface) of the valve seat 74, that is, the surface which allows the slide valve 75 to be seated thereon and separated therefrom is the fiat surface. However, the present invention is not limited to this example. There may be provided, for example, a configuration in which annular protrusions are provided on the side surface of the valve seat 74 so as to surround the outflow holes 74A, respectively, and in which the side surface (top surface) of the slide valve 75 is held in abutment against the respective annular protrusions. Further, there may be provided a configuration of providing a fixed orifice serving as a restriction through which the oil liquid flows between the slide valve 75 and the valve seat 74 even when, the slide valve 75 is held in abutment against the side surface of the valve seat 74.

In the fourth embodiment, description is made of, as an example, the case of employing the wave washer 76 as the spring configured to apply the set load to the slide valve 75. However, the present invention is not limited to this example, and various springs, for example, a coil spring and a coned disc spring may be used as long as the spring can apply the set load determining the relief pressure of the damping force adjusting valve.

In the fourth embodiment, description is made of, as an example, the case of employing paraffin wax as the high-cubical-expansion-coefficient member 79. However, the present invention is not limited to this example, and various members (materials) may be used as long as the member is made of a material, such as synthetic rubber, providing a required cubical expansion coefficient, that is, a material having a high cubical expansion coefficient in accordance with the temperature change.

In the fourth embodiment, description is made of, as an example, the case of the configuration of providing the damping force adjusting valve 71 on the downstream side of the electrode passage 19. However, the present invention is not limited to this example, and there may be provided, for example, a Configuration of providing the damping force adjusting valve on the upstream side (for example, in a vicinity of the oil holes 3A in the inner tube 3) of the oil passage. In other words, the designs of the shock absorber and the damping force adjusting valve may be changed without departing from the gist of the present invention.

In the respective embodiments, description is made of, as an example, the case of the configuration of arranging the shock absorber 1 in the vertical direction. However, the present invention is not limited to this example. For example, the shock absorber 1 may be arranged in a desired direction in accordance with an installation subject, for example, arranged in a tilted direction as long as aeration does not occur.

In the first embodiment, description is made of, as an example, the case of the configuration of the adjusting valve 21 without the urging force adjusting device 77 (that is, the high-cubical-expansion-coefficient member 79) of the fourth embodiment. However, the present invention is not limited to this example. There may be provided, for example, a configuration in which the adjusting valve includes a member having a high cubical expansion coefficient in accordance with the temperature change, and thus the set load changes in accordance with the temperature change as in the fourth embodiment. This holds true for the second embodiment and the third embodiment.

In the respective embodiments, description is made of, as an example, the case of the configuration in which the working fluid 2 flows from the top end side toward the bottom end side in the axial direction. However, the present invention is not limited to this example. There may be provided a configuration in which the working fluid 2 flows from the one end side toward the another end side in the axial direction in accordance with the arrangement direction of the shock absorber 1, for example, a configuration in which the working fluid 2 flows from the bottom end side toward the top end side, a configuration in which the working fluid 2 flows from a left end side (or a right end side) toward the right end side (or the left end side), and a configuration in which the working fluid 2 flows from a front end side (or a rear end side) toward the rear end side (or the front end side).

In the respective embodiments, description is made of, as an example, the case of the configuration of employing the electro-rheological fluid (ER fluid) as the working fluid 2 serving as the functional fluid. However, the present invention is not limited to this example. For example, magneto-rheological fluid (MR fluid) having a characteristic that changes in accordance with magnetic field may be employed as the working fluid serving as the functional fluid. When the magneto-rheological fluid is used, there may be provided a configuration in which the electrode tube 18, which is the intermediate tube, is switched from the electrode to a magnetic pole (in other words, magnetic field from a magnetic field supply part is applied to a magnetic pole tube, which is the intermediate tube). In this case, for example, the magnetic field is generated by the magnetic field supply part (in the magnetic pole passage) between the inner tube and the magnetic pole tube, and the magnetic field is variably controlled to variably adjust the generated damping force. Further, the holding members 11, 16, 45, 53, and 54, the isolators 63, and the like for the insulation may be made of, for example, a non-magnetic material.

In the respective embodiments, description is made of, as an example, the case of applying the shock absorbers 1 as the cylinder devices to a four-wheel vehicle. However, the present invention is not limited to this example. For example, the shock absorber 1 may widely be used as various shock absorbers (cylinder devices) configured to absorb shock of a subject of the shock absorbing, for example, a shock absorber used for a two-wheel vehicle, a shock absorber used for a railway vehicle, a shock absorber used for various machine devices including general industrial devices, and a shock absorber used for a building. Further, the respective embodiments are examples, and it should be understood that the configurations of the different embodiments may be partially replaced by or combined with one another.

According to the above-mentioned embodiments, the damping force characteristic can be tuned. In other words, the damping force characteristic of the cylinder device can be tuned as desired based on the setting of the adjusting valve provided in the first passage in addition to the adjustment of the damping force generated when the functional fluid passes through the intermediate passage (electrode passage or magnetic pole passage).

Specifically, according to the embodiments, the adjusting valve configured to generate the damping force is provided in the first passage configured to allow the first chamber and the reservoir to communicate with each other via the intermediate passage. Therefore, the cylinder device can obtain the damping force based on the passage of the functional fluid, which is the working fluid, through the intermediate passage and the damping force based on the passage of the functional fluid through the adjusting valve. Thus, the respective damping force characteristics in the piston low speed range, the piston medium speed range, and the piston high speed range can be tuned as desired by adjusting the orifice area, the spring stillness, the port area, and the like of the adjusting valve. As a result, the damping force characteristics can be tuned as desired by a method other than the adjustment of the damping force through the voltage adjustment and the like when the functional fluid passes through the intermediate passage, thereby being capable of increasing the degree of freedom of the tuning. In other words, a plurality of types of the cylinder device having the damping force characteristics different from one another in accordance with the types, the specifications, and the like of the vehicle can be provided by adjusting (setting) the adjusting valve, thereby being capable of reducing the mass production cost.

According to the embodiments, the adjusting valve includes the annular on-off valve provided on the downstream side of the intermediate passage, and the elastic member configured to urge the on-off valve. Therefore, the damping force characteristic can finely be tuned by adjusting the spring stiffness (elastic force and urging force) of the elastic member, and the orifice area and the port area of the on-off valve. For example, when the on-off valve is formed of a disc valve, the damping force characteristic may be tuned as desired only by adjusting (changing) the disc valve. As a result, the component cost can be reduced, and the mass production cost can also be reduced also in this respect. Further, (the on-off valve of) the adjusting valve is provided on the downstream side of the intermediate passage. Thus, for example, when the cylinder device is arranged in the vertical direction, the entry (counter flow) of the high pressure gas in the reservoir into the intermediate passage can also be prevented.

According to the embodiments, the first passage causes the intermediate passage to communicate with the reservoir via the body valve, and the adjusting valve is provided in the first passage of the body valve. With this configuration, the adjusting valve may be built into the valve body originally provided. As a result, for example, the increases in the complexity and the size of the adjusting valve and the increase in the number of components of the adjusting valve can be prevented.

According to the embodiments, the piston includes the first check valve which is configured to permit only the flow of the functional fluid from the second chamber side to the first chamber side, and the body valve includes the second check valve which is configured to permit only the flow of the functional fluid from the reservoir side to the second chamber side. Therefore, in the cylinder device, which is the shock absorber having the uni-flow structure, the damping force characteristic can be tuned in a wider range by providing the adjusting valve in the first passage connected to the outlet side (downstream side) or the inlet side (upstream side) of the intermediate passage.

According to the embodiments, the adjusting valve is configured to change the set load of the adjusting valve through the volume change in the member having a high cubical expansion coefficient in accordance with the temperature change. Therefore, the characteristic change (change in damping force) in the entire cylinder device caused by the temperature change in the working fluid, which is the functional fluid, can be suppressed (compensated) by the adjusting valve.

Further, according to, the fourth embodiment, it is possible to prevent the damping force from becoming excessive as well as tune the damping force characteristic.

In other words, according to the embodiments, the shock absorber includes the damping force adjusting valve (adjusting valve) configured to change the relief pressure in accordance with the temperature change in addition to the oil passage configured to generate the electric potential difference. Therefore, the shock absorber can obtain the damping force based on the passage of the electro-rheological fluid serving as the working fluid through the oil passage and the damping force based on the passage of the electro-rheological fluid through the damping force adjusting valve. As a result, the characteristic change (change in damping force) in the entire shock absorber caused by the temperature change in the electro-rheological fluid can be suppressed (compensated) by the change in relief pressure of the damping force adjusting valve. In this case, the damping force adjusting valve is configured to adjust the damping force through the change not only in the set load but also in the relief pressure in accordance with the temperature, thereby being capable of adjusting the damping force independently of the piston speed. In other words, the damping force can be adjusted as desired regardless of the piston speed. As a result, even when the piston speed becomes higher, it is possible to prevent the damping force from becoming excessive.

According to the embodiments, the damping force adjusting valve is provided in series with the oil passage. Therefore, the damping force of the entire shock absorber can be the sum of the damping force based on the passage of the electro-rheological fluid through the oil passage and the damping force based on the passage of the electro-rheological fluid through the damping force adjusting valve. In other words, the decrease in the damping force resulting from the decrease in the viscosity of the electro-rheological fluid caused by the temperature increase can be cancelled out based on the increase in the damping force resulting from the increase in the relief pressure of the damping force adjusting valve caused by the temperature increase. As a result, the characteristic change (change in damping force) of the entire shock absorber caused by the temperature change in the electro-rheological fluid can be suppressed (compensated) at a high level.

As the cylinder device according to the embodiments described above, for example, the following modes are conceivable.

As a first mode of the cylinder device, there is provided a cylinder device, including: an inner tube in which functional fluid having a characteristic that is changed by electric field or magnetic field is sealed; a piston, which is provided in the inner tube so as to be slidable, and defines a first chamber on a rod side and a second chamber on a bottom side in the inner tube; a piston rod, which has one end coupled to the piston, and another end extending to an outside of the inner tube via the first chamber; an intermediate tube, which is provided on an outer side of the inner tube, and forms, together with the inner tube, an intermediate passage serving as an electrode passage or a magnetic pole passage communicating with the first chamber; an outer tube, which, is provided around an outer periphery of the intermediate tube, and forms, together with the intermediate tube, a reservoir communicating with the intermediate passage; a body valve, which is provided on one end side of the inner tube, and is configured to allow and block communication between the second chamber and the reservoir; and an adjusting valve, which is configured to generate a damping force, and is provided in a first passage configured to allow the first chamber and the reservoir to communicate with each other via the intermediate passage.

As a second mode, in the first mode, the adjusting valve includes an annular on-off valve provided on a downstream side of the intermediate passage, and an elastic member configured to urge the on-off valve.

As a third mode, in the first mode or the second mode, the first passage is configured to allow the intermediate passage and the reservoir to communicate with each other via the body valve, and the adjusting valve is provided in the first passage of the body valve.

As a fourth mode, in any one of the first mode to the third mode, the piston includes a first check valve which is configured to permit only a flow of the functional fluid from the second chamber side to the first chamber side, and the body valve includes a second check valve which is configured to permit only a flow of the functional fluid from the reservoir side to the second chamber side.

As a fifth mode, in any one of the first mode to the fourth mode, the adjusting valve is configured to change a set load of the adjusting valve through a volume change of a member having a high cubical expansion coefficient in accordance with a temperature change.

As a sixth mode, there is provided a cylinder device, including: a cylinder in which working fluid is sealed; a piston, which is mounted through fitting into the cylinder so as to be slidable; a piston rod, which is coupled to the piston, and extends to an outside of the cylinder; and an oil passage, which is configured to apply a resistance to the fluid caused to flow by slide of the piston in the cylinder, in which electro-rheological fluid (fluid to be tilled) is able to be filled in the cylinder, and a generated damping force is controllable by generating an electric potential difference in the oil passage and controlling viscosity of the electro-rheological fluid which passes through the oil passage, in which a damping force adjusting valve is provided in the oil passage, and in which the damping force adjusting valve is configured to change a relief pressure by changing a set load of a spring provided in the damping force adjusting valve through a volume change in a member having a high cubical expansion coefficient in accordance with a temperature change, to thereby adjust the generated damping force.

As a seventh mode, in the sixth mode, the damping force adjusting valve is provided in series with the oil passage.

Description is made of only some embodiments of the present invention, but it is readily understood by a person skilled in the art that various changes and improvements can be made to the exemplified embodiment without practically departing from the novel teachings and advantages of the present invention. Thus, forms to which such changes and improvements are, made are also intended to be included in the technical scope of the present invention. The above-mentioned embodiments may be arbitrarily combined.

The present application claims a priority based on Japanese Patent Application No. 2015-131318 filed on Jun. 30, 2015 and Japanese Patent Application No. 2016-034290 filed on Feb. 25, 2016. All disclosed contents including Specification, Scope of Claims, Drawings, and Abstract of Japanese Patent Application No. 2015-131318 filed on Jun. 30, 2015 and Japanese Patent Application No. 2016-034290 filed on Feb. 25, 2016 are incorporated herein by reference in their entirety.

### REFERENCE SIGNS LIST

1 shock absorber (cylinder device), 2 working fluid (functional fluid, electro-rheological fluid), 3 inner tube (cylinder), 4 outer tube (cylinder), 6 piston, 7 retraction-side check valve (first check valve), 9 piston rod, 13, 41, 51, 61 bottom valve (body valve), 14, 42, 52, 62 valve body, 14E radial passage (first passage), 14F annular passage (first passage), 15 extension-side check valve (second check valve), 17 holding-member-side passage (first passage), 18 electrode tube (intermediate tube), 19 electrode passage (intermediate passage, oil passage), 21, 47 adjusting valve, 21A disc (on-off valve), 21B plate spring (elastic member) 45, 54 holding member, 45C1 radial passage (first passage), 54G axial passage (first passage), 46, 55 annular passage (first passage), 71 damping adjusting valve (adjusting valve), 76 wave washer (elastic member, spring), 79 high-cubical-expansion-coefficient member (member having a high cubical expansion coefficient), A reservoir chamber (reservoir), B rod-side oil chamber (first chamber), C bottom-side oil chamber second chamber)

1-7. (canceled)

8. A cylinder device, comprising:
an inner tube in which functional fluid having a characteristic that is changed by electric field is sealed;
a piston, which is provided in the inner tube so as to be slidable, and defines a first chamber on a rod side and a second chamber on a bottom side in the inner tube;
a piston rod, which has one end coupled to the piston, and another end extending to an outside of the inner tube via the first chamber;
an intermediate tube, which is provided on an outer side of the inner tube, and forms, together with the inner tube, an intermediate passage serving as an electrode passage communicating with the first chamber;
an outer tube, which is provided around an outer periphery of the intermediate tube, and forms, together with the intermediate tube, a reservoir communicating with the intermediate passage, functional fluid and a gas being sealingly contained in the reservoir;
a body valve, which is provided on one end side of the inner tube, and is configured to allow and block communication between the second chamber and the reservoir; and
an adjusting valve, which is configured to suppress the gas in the reservoir to flow into the intermediate passage, and which is provided downstream of the intermediate passage of a first passage configured to allow the first chamber and the reservoir to communicate with each other via the intermediate passage.

9. A cylinder device according to claim 8, wherein the adjusting valve comprises an annular on-off valve provided on a downstream side of the intermediate passage, and an elastic member configured to urge the on-off valve.

10. A cylinder device according to claim 8,
wherein the first passage is configured to allow the intermediate passage and the reservoir to communicate with each other via the body valve, and
wherein the adjusting valve is provided in the first passage of the body valve.

11. A cylinder device according to claim 8,
wherein the piston includes a first check valve which is configured to permit only a flow of the functional fluid from the second chamber side to the first chamber side, and
wherein the body valve includes a second check valve which is configured to permit only a flow of the functional fluid from the reservoir side to the second chamber side.

12. A cylinder device according to claim 8, wherein the adjusting valve is configured to change a set load of the adjusting valve through a volume change of a member having a high cubical expansion coefficient in accordance with a temperature change.

13. A cylinder device, comprising:
a cylinder in which working fluid is sealed;
a piston slidably fitted in the cylinder;
a piston rod, which is coupled to the piston, and extends to an outside of the cylinder; and
an oil passage, which is configured to apply a resistance to the fluid caused to flow by slide of the piston in the cylinder,
wherein electro-rheological fluid is able to be filled in the cylinder, and a generated damping force is controllable by generating an electric potential difference in the oil passage and controlling viscosity of the electro-rheological fluid which passes through the oil passage,
wherein a damping force adjusting valve is provided in the oil passage, and
wherein the damping force adjusting valve is configured to change a relief pressure by changing a set load of a spring provided in the damping force adjusting valve through a volume change in a member having a high cubical expansion coefficient in accordance with a temperature change, to thereby adjust the generated damping force.

14. A cylinder device according to claim 13, wherein the damping force adjusting valve is provided in series with the oil passage.
